(19) United States
(12) Patent Application Publication
(10) Pub. No.: US 2009/0172014 A1
(43) Pub. Date: Jul. 2, 2009

(54) Stream-Oriented Database Machine and Method

(76) Inventor: Raymond John Huetter, Naremburn (AU)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/064,505

(22) PCT Filed: Aug. 18, 2006
(86) PCT No.: PCT/AU2006/001179

§ 371 Date: Aug. 13, 2008

(30) Foreign Application Priority Data
Aug. 23, 2005 (AU) 2005904574

(51) Int. Cl. G06F 17/30

(52) U.S. Cl. 707/103 R; 707/E17.055

(57) ABSTRACT

An event stream processing device capable of processing larger numbers of events while simultaneously responding to queries. This is achieved through sequential storage of data, the maintenance in memory of information pertaining to the most recent events for each entity monitored and the aggregation of file read/write requests in a single thread which is capable of optimising the execution of those requests.

### 1 TECHNICAL FIELD

This invention concerns a machine comprising a scalable computing architecture for processing, storing and querying real-time, high-volume streams of event data. More particularly but not exclusively it also comprises a method for laying down data in storage locations.

### 2 BACKGROUND OF INVENTION

Over the last three decades of the computing industry, microprocessors and memory have followed Moore's Law—a continuing trend which has seen performance double every eighteen months. While significant advancements are being made in non-volatile memory and similar technologies, disk drives remain the persistent storage work-horse for the foreseeable future, particularly for high-volume applications.

Although disk drives have substantially increased in capacity and performance and have reduced in price, they have not had an exponential performance increase similar to microprocessors. Consequently, when viewed from a performance perspective, microprocessors and disk drives have never been further apart than they are today, and by all indications they will continue to diverge in the future.

Due to RFID and similar sensor-based technologies, event stream volumes are expected to go through a significant growth period over the next three decades, which may also be exponential. Anecdotal evidence indicates that relational databases cannot cost-effectively ingest, index, store and replay event streams today—yet alone cope with predicted future volumes.

It is an object of the present invention to address or ameliorate one or more of the above-mentioned disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### 3 SUMMARY OF THE INVENTION

Accordingly in one broad form of the invention there is provided a high data throughput special purpose device; said device comprising at least one processor in communication with an IO system, a memory and persistent storage in the form of at least one disk; said device adapted to receive a substantially continuous stream of status data pertaining to the current state of a finite number of objects via said IO system; said device keeping said current state of said finite number of said objects in memory while writing and reading an indefinite amount of indexed history sequentially stored on said at least one disk; thereby to construct on said at least one disk a sequenced, time-ordered history of said status data extending back to a predetermined point in time.

Preferably said device keeps said current state of said finite number of said objects in memory while simultaneously writing and reading an indefinite amount of indexed history sequentially stored on said at least one disk.

Preferably said device is a hybrid of memory-oriented and disk-oriented database systems.

Preferably said status data includes at least a first parameter and a second parameter for each said object; said first parameter comprising time data.

Preferably said second parameter is location data pertaining to the location of said object at a given point in time.

Preferably said device comprises one or more central processing units (CPU's), memory comprising one or more memory units, one or more persistent storage units, one or more communication sockets, and a clock.

Preferably said devise is programmatically arranged as an interconnected set of multi-threaded processing units (here within referred to as agents) executing a set of event processing, query processing, disk I/O, network I/O and housekeeping tasks.

Preferably said device accepts one or more events streams comprising event data about events pertaining to objects.

Preferably said device groups predetermined amounts of event data into tasks which represent work to be done.

Preferably said device keeps the current location and state of the objects in said memory, in concurrent data structures, said data structures indexed by at least the identity and location of respective said objects;

Preferably said device processes said tasks, thereby changing the location and state of said objects held in said memory.

Preferably said device writes a stream of time-ordered records of changes to said location and state data of said objects onto said persistent storage in a sequential manner, indexed by at least time, object identity and location, where said index is also written concurrently and sequentially with said records.

Preferably said device executes query tasks by retrieving relevant said location and state data about said objects from said memory or said persistent storage.

Preferably said device locates and retrieves said objects in said memory by either said identity or said location.

Preferably said device locates and retrieves said records in persistent storage by either said identity or said location or by time.

Preferably said device is set to have a finite number of steps and an upper time-space processing limit to each step thereby to facilitate real time processing.

Preferably said status data is stored as a record, one for each said object for a unique value of said first parameter and wherein the fully processed records are collected in groups and each group given a sequence number to be recorded with it.

In a further broad form of the invention there is provided a method of processing and storing a substantially continuous stream of status data pertaining to the state of a finite number of objects; said method comprising maintaining said current state of said finite number of said objects in memory while sequentially writing and reading an indefinite amount of indexed history of said status data to at least one disk; thereby to provide current status of said objects from memory and history of said status data from said disk.

Preferably; said method comprises maintaining said current state of said finite number of said objects in memory while simultaneously sequentially writing and reading an indefinite amount of indexed history of said status data to at least one disk.

Preferably said status data includes at least a first parameter and a second parameter for each said object; said first parameter comprising time data.

Preferably said second parameter is location data pertaining to the location of set object at a given point in time.

Preferably said method includes programming a device comprising one or more central processing units (CPU's), memory comprising one or more memory units, one or more persistent storage units, one or more communication sockets, and a clock;

Preferably said device is programmatically arranged as an interconnected set of multi-threaded processing units (here within referred to as agents) executing a set of event processing, query processing, disk I/O, network I/O and housekeeping tasks;

Preferably said device accepts one or more events streams comprising event data about events pertaining to objects.

Preferably said device is set to have a finite number of steps and an upper time-space processing limit to each step thereby to facilitate real time processing.

Preferably said status data is stored as a record, one for each said object for a unique value of said first parameter and wherein the fully processed records are collected in groups and each group given a sequence number to be recorded with it.

Preferably there are different types of specialised agents, including:
A controller agent responsible for overall control of device;
Ingestion agents responsible for ingestion of event stream data;
Query agents responsible for servicing query requests and,
Common agents for providing general purpose services.

In a further broad form of the invention there is provided a machine
Comprising one or more central processing units (CPU's), memory comprising one or more memory units, one or more persistent storage units, one or more communication sockets, and a clock;
Programmatically arranged as an interconnected set of multi-threaded processing units (here within referred to as agents) executing a set of event processing, query processing, disk I/O, network I/O and housekeeping tasks;
Accepting one or more events streams comprising event data about events pertaining to objects;
Grouping predetermined amounts of event data into tasks which represent work to be done;
Keeping the current location and state of the objects in said memory, in concurrent data structures, said data structures indexed by at least the identity and location of respective said objects;
Processing said tasks, thereby changing the location and state of said objects held in said memory;
Writing a stream of time-ordered records of changes to said location and state data of said objects onto said persistent storage in a sequential manner, indexed by at least time, object identity and location, where said index is also written concurrently and sequentially with said records;
Executing query tasks by retrieving relevant said location and state data about said objects from said memory or said persistent storage;
Locating and retrieving said objects in said memory by either said identity or said location; and
   locating and retrieving said records in persistent storage by either said identity or said location or by time.
In a further broad form of the invention there is provided a scalable stream-oriented database machine for processing and storing streams of data comprising a chronological sequence of events associated with items, and selectively replaying stored data; the architecture comprising:
   A data stream receiving port to receive one or more streams of data, and to arrange the data events in parallel queues, each queue being partitioned into the same series of chronologically ordered time slots, each data event being allocated to the appropriate time slot in one of the queues;
   A cache in which is kept a running total of the events for each item received into a queue, as well as a reference to the last event processed for that item; and
   A pipeline of parallel software processing agents, the first of which receives and part-process the first event in the first time slot in each queue and then passes the part-processed events to a second agent which continues processing while the first agent starts processing the next event, and so on until the last agent of the pipeline writes streams of fully processed records of the events in time sequence order to record files in respective memories.

Preferably the fully processed records are collected in groups and each group given a sequence number to be recorded with it.

Preferably in parallel to writing the records the device writes a trail marker entry about each record.

Preferably the trail marker entries are stored in the same files as the records.

Preferably each trail marker has a reference to its corresponding record, and a reference to the previous trail marker which relates to the same item.

Preferably a time marker is periodically written into the trail file.

Preferably each time marker contains a reference to previous time markers.

Preferably the time markers in one file also reference the corresponding time markers in neighbouring files.

Preferably the device periodically writes the contents of the cache to snapshot file.

Preferably the device computes the difference between two snapshots, thereby calculating the work done between the two snapshots.

Preferably the device supports a stream query which requests replay of an event stream between preselected times.

Preferably the device supports an item query which requests the current state of an item.

Preferably the device supports a history query which requests the history of an item.

Preferably the device supports a long running query that will fetch qualifying records from a given time forward.

Preferably each of the software processing agents is responsible for a logically separate stage of processing.

Preferably the agents are loosely coupled so that the sequence of agents that a task moves through as it is processed is not necessarily determined a priori.

Preferably each stage is multi-threaded and able to execute concurrently.

Preferably each thread services its own task queue within the agent.

Preferably there are different types of specialised agents, including:
A controller agent responsible for overall control of device;
Ingestion agents responsible for ingestion of event stream data; and,
Query agents responsible for servicing query requests.

Preferably the agents operate so that later events do not get processed before earlier events.

Preferably said device is configured as a Fan-In device arranged to query a set of other machines and store the results.

Preferably said device is configured as a Fan-Out device arranged to query subsets of data.

Preferably said device is configured as a Store and Forward device able to retain the data it ingests until such data has been queried by another device.

Preferably said device is configured as a Propagation device arranged to query definitions.

Preferably said device is configured as a Control device controlled and coordinated by another device.

In a further broad form of the invention there is provided a method for storing streams of data comprising a chronological sequence of events associated with items, and selectively replaying stored data; the architecture, the method comprising the steps of:
Receiving one or more streams of data, and arranging the data events in parallel queues;
Partitioning each queue into the same series of chronologically ordered time slots;
Allocating each data event to the appropriate time slot in one of the queues;
Keeping running total of the events for each item received into a queue, as well as a reference to the last event processed for that item; and
Processing the first event in the first time slot in each queue using a pipeline of parallel software processing agents, the first of which receives and part-process the first event in the first time slot in each queue and then passes that part-processed event to a second agent which continues processing while the first agent starts processing the next event, and so on until the last agent of the pipeline writes streams of fully processed records of the events in time sequence order to record files on respective memories.

Preferably said method includes the further step of collecting the fully processed records in groups and giving each group a sequence number to be recorded with it.

Preferably said method includes the further step of writing a trail marker entry about each record in parallel to writing the records the device.

Preferably said method includes the further step of storing the trail marker entries in the same files as the records.

Preferably said method includes the further step of referencing each trail marker to its corresponding record, and to the previous trail marker which relates to the same item.

Preferably said method includes the further step of writing a time marker periodically into the trail file.

Preferably said method includes the further step of inserting in each time marker a reference to previous time markers.

Preferably said method includes the further step of referencing the time markers in one file to the corresponding time markers in neighbouring files.

Preferably said method includes the further step of periodically writings the contents of the cache to snapshot file.

Preferably said method includes the further step of computing the difference between two snapshots, thereby calculating the work done between the two snapshots.

Preferably a stream query requests replay of an event stream between preselected times.

Preferably an item query requests the current state of an item.

Preferably a history query requests the history of an item.

Preferably a long running query will fetch qualifying records from a given time forward.

Preferably each of the software processing agents is responsible for a logically separate stage of processing.

Preferably the agents are loosely coupled so that the sequence of agents that a task moves through as it is processed is not necessarily determined a priori.

Preferably each stage is multi-threaded and able to execute concurrently.

Preferably each thread services its own task queue within the agent.

Preferably there are different types of specialised agents, including:
A controller agent responsible for overall control of device;
Ingestion agents responsible for ingestion of event stream data; and,
Query agents responsible for servicing query requests.

Preferably the agents operate so that later events do not get processed before earlier events.

### 4 BRIEF DESCRIPTION OF DRAWINGS

FIG. 1 is a block diagram of an external view of the stream-oriented database machine;

FIG. 2 is a block diagram of an internal view of the stream-oriented database machine;

FIG. 3(a) is a diagram of an event stream arriving at the stream-oriented database machine;

FIG. 3(b) is a diagram of events being written to disk;

FIG. 3(c) is a diagram of trail markers being written to a trail file;

FIG. 3(d) is a diagram of tracking the last trail marker for each item;

FIG. 3(e) is a diagram of time markers appearing in trail files;

FIG. 3(f) is a diagram showing the use of the cache;

FIG. 3(g) is a diagram showing snapshot files being used to satisfy a query;

FIG. 3(h) is a diagram showing an optimized record file;

FIG. 3(i) is a diagram showing the correspondence of time markers between files;

FIG. 4 is diagram of stream-oriented database machine system architecture;

FIG. 5(a) is a diagram of an agent;

FIG. 5(b) is a diagram showing how tasks are pipelined through a set of agents;

FIG. 5(c) is a diagram showing how events from multiple streams are regulated;

FIG. 5(d) is a diagram showing how events are processed in time-delimited batches;

FIG. 5(e) is a diagram showing how records are collected into record sets;

FIG. 5(f) is a diagram showing how record sets are collected into record groups;

FIG. 5(g) is a diagram showing how time markers are written periodically to the files;

FIG. 6 is a diagram showing the components of the cache;

FIG. 7 is a diagram showing how items are collected into classification groups;

FIG. 8(a) is a diagram showing the general format of an item;

FIG. 8(b) is a diagram showing the definition of an item;

FIG. 8(c) is a diagram showing the general format of an event message;

FIG. 8(d) is a diagram showing the definition of an event message;

FIG. 9(a) is an activity table that keeps time-ordered correlations of record groups and stream queries;

FIG. 9(b) is an activity table augmented with a time line structure which holds a series of time markers independent of ingestion and query activity;

FIG. 10(a) is a diagram showing a controller and its relationship to other agents;

FIG. 10(b) is a diagram showing worker threads examining queue lengths to balance load across multiple threads;

FIG. 10(c) is a diagram showing worker threads synchronized by one worker thread which makes decisions;

FIG. 10(d) is a diagram showing an agents with multiple worker threads producing batches of tasks of roughly equal numbers;

FIG. 11 is a diagram showing ingestion flow;

FIG. 12 is a diagram showing events chronologically sequenced according to their record group;

FIG. 13 is a diagram showing steam queries stepping through records sets;

FIG. 14 is a diagram showing query flow;

FIG. 15 is a diagram showing records becoming candidates for removal after being used by queries;

FIG. 16 is a diagram showing progress markers during the ingestion of a query;

FIG. 17 is a diagram showing a file request scheduler agent;

FIG. 18 is a diagram showing the request schedule;

FIG. 19 is a diagram showing the file operator;

FIG. 20(a) is a diagram showing the sets of disk drives in a disc farm;

FIG. 20(b) is a diagram showing each subset of disk drives managed as a disk matrix;

FIG. 20(c) is a diagram showing the system tracking the current set of files in each disk subset;

FIG. 21 is a diagram of the layout of an entry reference;

FIG. 22(a) is a diagram showing stream-oriented database machines arranged in a fan in configuration;

FIG. 22(b) is a diagram showing stream-oriented database machines arranged in a fan out configuration;

FIG. 22(c) is a diagram showing stream-oriented database machines arranged in a store and forward configuration;

FIG. 22(d) is a diagram showing stream-oriented database machines arranged in a propagation configuration;

FIG. 22(e) is a diagram showing stream-oriented database machines arranged in a control configuration;

FIG. 23 is a diagram showing networks formed using query and ingestion capabilities;

FIG. 24 is a diagram showing a task;

FIG. 25 is a diagram showing an agent with worker threads servicing queues of tasks;

FIG. 26 is a diagram showing the primary agents (Answer-Socket, Read-Socket, Write-Socket, Ingest-Events, Disk-IO, Process-Query, Timepoint-Generator, Housekeeping) comprising the system;

FIG. 27 is a diagram showing the cache consisting of the item trees, the items, the location tree and the location bins;

FIG. 28 is a diagram showing the timeline consisting of a set of time points, each with a bucket;

FIG. 29 is a diagram showing a bucket with records on each of a number of disk-lines;

FIG. 30 is a diagram showing a set of disks organized into disk lines;

FIG. 31 is a diagram showing record files with records, with backward references to previous records, delineated by time-markers, with backward references to previous time-markers;

FIG. 32 is a diagram showing a hypothetical usage of the system;

FIG. 33 is a flowchart describing how threads execute tasks;

FIG. 34 is a flowchart describing how a thread in the Answer-Socket agent performs the Answer-Socket task;

FIG. 35 is a flowchart describing how a thread in the Read-Socket agent performs the Read-Socket task;

FIG. 36 is a flowchart describing how a thread in the Ingest-Events agent performs the Ingest-Events task;

FIG. 37 is a flowchart describing how a thread in the Disk-IO agent performs the Write-Events task;

FIG. 38 is a flowchart describing how a thread in the Write-Socket agent performs a Write-Socket task;

FIG. 39 is a flow chart describing how a thread in the Generate-Timepoint agent performs a Generate-Timepoint task;

FIG. 40 is a flowchart describing how a thread in the Ingest-Events agent performs a See-Timepoint task;

FIG. 41 is a flowchart describing how a thread in the Disk-IO agent performs a Write-Timepoint task;

FIG. 42 is a flowchart describing how a thread in the Housekeeping agent performs a Purge-Timeline task;

FIG. 43 is a flowchart describing how a thread in the Process-Query agent performs a Query-Request task;

FIG. 44 is a flowchart describing how a thread in the Process-Query agent performs a Query-Stream task;

FIG. 45 is a flowchart describing how a thread in the Process-Query agent performs a Query-History task;

FIG. 46 is a flowchart describing how a thread in the Process-Query agent performs a Restore-Timepoint task;

FIG. 47 is a flowchart describing how a thread in the Disk-IO agent performs a Read-Timepoint task;

FIG. 48 is a diagram showing the event streams for the toll-gate usage example;

FIG. 49 is a diagram showing data associated with the example event;

FIG. 50 is a diagram showing data kept in an example item;

FIG. 51 is a diagram showing an example location tree;

FIG. 52 is a diagram showing two example location bins with two lists in each bin;

FIG. 53 is a diagram showing two example item trees with six cars in each tree;

FIG. 54 is a diagram showing a set of example items;

FIG. 55 is a diagram showing an example of two disks with time-markers and event records (prior to the new events being processed);

FIG. 56 is a diagram showing an example of two cars moving between location bins;

FIG. 57 is a diagram showing two example items being processed and the corresponding records produced; and

FIG. 58 is a diagram showing two example disk units with two new event records.

FIG. 59 is a diagram showing a toll-gate usage example with tasks flowing between the agents;

FIG. 60 is a diagram showing a data positioning methodology on a hard disk platter according to an exemplary application of the invention;

FIG. 61 is a diagram showing an alternative format of an item being a set of attribute-value pairs.

### 5 DETAILED DESCRIPTION OF PREFERRED EMBODIMENTS

### 5.1 First Preferred Embodiment

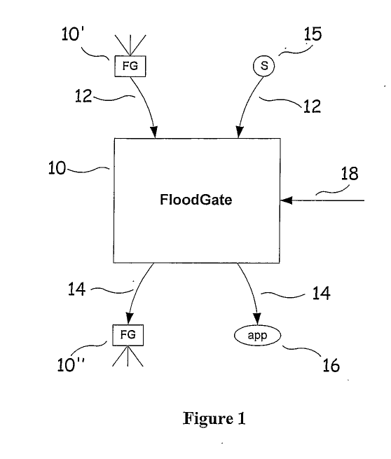

A first preferred embodiment of a stream oriented database machine will now be described with reference to FIGS. 1 to 23.

### 5.1.1 Detailed Description of First Preferred Embodiment

A computer is a machine which consumes energy to do work. Relational databases are sophisticated software systems which use the resources of the machine in a particular way in order to support a programming model based on set theory.

General purpose disk-based relational databases maintain sets of data on disk drives, primarily by viewing disks as random-access devices. No a-priori knowledge is assumed about the data. Consequently data (and indexes) tend to be stored and retrieved randomly from the disks.

Disks can be used either as a random access device or as a sequential device—but the read/write performance of a disk when used sequentially can be substantially greater (by orders of magnitude) compared to when the disk is used in a random manner. Therefore using a general purpose relational database to ingest real-time, high-volume event streams would tend to use more machine resources than a special purpose database which used disks in a sequential manner—all other things being equal. Conversely a general purpose relational database would be less efficient, take longer, or would have lower throughput than a special purpose database.

Alternatively, a general purpose memory-based relational database will tend to have greater throughput potential than a disk-based relation database, but will be significantly limited to the amount of data it can hold by the amount of memory in the machine.

Many event streams are a continuous sequence of events pertaining to a finite number of physical objects and their usage in time and space.

Given that modern 64-bit computers can have large amounts of main memory and a very large number of disk drives, in at least one preferred embodiment of the invention there is provided an efficient high-throughput special purpose device which can be built by keeping the current state of a finite number of objects in memory while writing and reading an indefinite amount of indexed history on disk—particularly where that history is written and retrieved in a sequential manner. In this preferred form the device is a hybrid of memory-oriented and disk-oriented database systems.

### 5.1.2 FloodGate

In a preferred form there is provided a scalable stream-oriented database machine (in this specification termed “FloodGate”) for storing streams of data comprising a chronological sequence of events associated with (preferably but not exclusively) physical objects, and selectively retrieving stored data; the architecture comprising:
A data stream receiving port to receive one or more streams of data;
Grouping events as they arrive from data streams into tasks (which represent work to be done);
A cache in which items keep running totals of the events for each object received, as well as a reference to a record of the last event processed for that object; and
A pipeline of parallel software processing agents, the first of which selects and part-processes the first task in each queue and then passes the part-processed task to a second agent which continues processing while the first agent starts processing the next task, and so on until the last agent of the pipeline writes streams of fully processed records of the events in time sequence order to record files in respective persistent storage.

In FIG. 1 the stream-oriented database machine 10 can be seen to accept an event stream 12 from sensor 15 and from other stream-oriented database machines 10′. We also see that the Flood Gate 10 can forward or propagate query streams 14 in response to queries to applications 16 or other stream-oriented database machines 10″. Each stream-oriented database machine 10 is set up and controlled via commands 18 it receives. The stream-oriented database machines 10 can be used in a variety of ways, such as to replay a subset of the event stream, accurately produce current position reports, or to fetch the known history of a particular item.

Overall in this embodiment the machine provides a specialized solution for collecting, storing and querying real-time data that is significantly simpler and far more cost effective than relational database technology.

Performance goals for the machine of this embodiment were:
Performance—ingest and index>50,000 events per second per gigahertz CPU;
Response—respond to events within 100 milliseconds;
Capacity—track 100 million items per 32 GB of memory;
Scalability—all other things being equal, doubling machine resources roughly doubles performance and capacity;
Integration—readily integrates with applications and databases; and
Adaptability—useful for a variety of real-time event streams, including RFID, video-on-demand and transaction processing.

In this embodiment the machine may process and write (in a streaming manner) high-volume parallel data streams to any number of persistent storage devices, for instance disk-drives or flash-drives, while continuously indexing, tallying and/or summarizing that data. The machine can also replay sub-sets of the data streams and service queries about specific events and items in those streams.

In this embodiment the machine may provide a solution to the basic problem of how to build a network which cost-effectively tracks objects—determining how many there are by type, where they are and where they have been, and when they were moved or used—when there is a high rate of movement or usage of such objects.

In this embodiment the machine may exhibit constant performance under load over time. Because of its design, the machine does not slow down as it stores larger amounts of history—the machine continues to ingest and store real-time data at the same rate at which it starts.

In this embodiment the machine may replay the data streams. Specifically it is able to replay past events in real-time while simultaneously continuing to ingest new data.

In this embodiment the machine may periodically write the contents of the cache to snapshot file. These “snapshots” reflect the situation at a particular point in time.

In this embodiment the machine may compute the difference between two snapshots, thereby calculating the work done between the two snapshots.

In this embodiment the machine may support a stream query which requests replay of an event stream between preselected times.

In this embodiment the machine may support an item query which requests the current state of an item.

In this embodiment the machine may support a history query which requests the history of an item.

In this embodiment the machine may support a long running query that will fetch qualified records from a given time forward.

Each of the software processing agents of the pipeline may be responsible for a logically separate stage of processing. The agents may be loosely coupled so that the sequence of agents that a task moves through as it is processed is not necessarily determined a priori.

Each stage may be multi-threaded and able to execute concurrently. Each thread may service its own task queue within the agent.

There may be different types of specialised agents, for instance as follows:
A controller agent may be responsible for overall control of machine;
Ingestion agents may be responsible for ingestion of event stream data;
Query agents may be responsible for servicing query requests. When queried the machine may replay events in the same order they were ingested, in real-time; and
Common agents may supply common base services. This may include disk I/O, network I/O, timing services, file purging, buffer management, file purging, and restart/reload.

The agents operate so that later events do not get processed before earlier events and an agent may be tasked with regulating incoming streams to achieve this. Alternatively, or in addition a thread may examine the length of the task queues in the next agent and pass its completed task to the shortest queue. The threads in an agent may be synchronised with other.

As shown in FIGS. 22(a)-(e) a stream-oriented database machine 10 of this kind may be configured within a network in several different ways:
A Fan-In machine may be arranged to query a set of other machines and store the results;
A Fan-Out machine may be arranged to query subsets of data. Multiple machines may be connected to a Fan-Out machine, and each may query a subset of the history from the Fan-Out machine. A more complex machine may be built up of cascaded layers in this way;
A Store and Forward machine may be able to retain the data it ingests until such data has been queried by another machine;
A Propagation machine may be arranged to query definitions. Propagation refers to rippling definitions and configuration settings through a network. One machine queries another about its configuration and settings. By ingesting such query results, a machine can configure itself from another; and
A Control machine may be controlled and coordinated by another machine.

A collection of such machines may provide a highly reliable, real-time event collection and distribution networks of arbitrary size.

In this embodiment the machine has a number of key features which will be explained in greater detail below:
One form of the machine is standalone machine. The interface to the system is through TCP/IP sockets. This includes ports for data, query and management;
A concurrent agent model permits a high-degree of scalability;
Event data is written to any number of disks in parallel;
Data is written to any given disk in an optimum sequential manner;
An indefinite history may be kept about a finite but large number of objects;
Indexing is O(1), remaining constant as new events are recorded by the machine;
History records are written in a manner which enables them to be retrieved from disk using a skip sequential technique; and
Because of its indexing and disk I/O techniques the machine performs consistently under load over time—it does not slow down as more data is ingested.

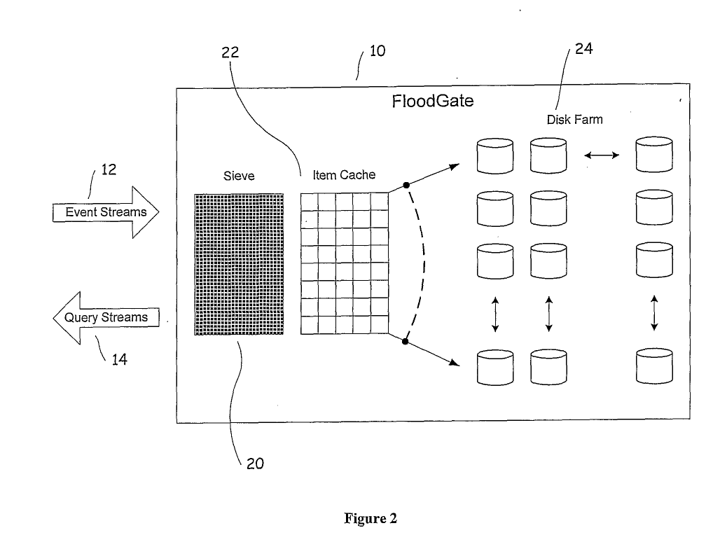

FIG. 2 shows the machine 10 ingesting a high-volume event stream 12. Within this conceptualization we can see that the machine:
Accepts streams of events 12 which relate to objects that are being tracking;
Sieves 20 that event stream 12 in order to determine which items are changing;
Updates the items held within its cache 22 in memory;
Indexes and writes records of the events to disk 24; and
Answers queries 14 pertaining to the events streams and tracked objects within those streams.

### 5.1.3 Classification

Two important pieces of information are typically available in many sensor based applications: category and location. These two pieces of information form a very useful classification scheme.

In terms of categorization of objects, for example, the international consortium EPCglobal has defined a standard numbering scheme for RFID tags which includes category information: e.g. this item is a tank; this item is an egg etc. And in terms of location, when an RFID tag is sensed, it is sensed somewhere in space-time.

The conjunction of category with location provides a classification scheme which can be readily supplied by the machine as a built in feature.

The availability of a classification scheme provides an alternate view or ordering of the items held by the machine. This enables another type of query—the summary query—which is a report of the items in the system presented in category-location order.

### 5.1.4 Real-Time Tallying

We discuss how the current state of an item is maintained in memory by way of an example. A phone bill typically itemizes the customer's usage by category. In this example let us assume there are two types of usage—local, domestic and international—and each is charged at a different rate.

The following table shows a hypothetical phone bill, showing the date and time each call was made, the type (or category) of the call, how long the call took and the charge for the call. The last line presents the grand total for the billing period.

| Date-time | Call Type | Duration | Cost |
|---|---|---|---|
| 10 Mar. 2005 | Local | 10:20 | $1.20 |
| 11:52 | | | |
| 12 Mar. 2005 | Local | 5:10 | $0.60 |
| 13:15 | | | |
| 14 Mar. 2005 | Intl | 6:30 | $10.00 |
| 17:05 | | | |
| | | Total | $11.80 |

Computer systems would typically keep records of phone usage in a manner which supports the above approach—except for the cost column—which would be calculated at the end of the billing period according to the customer's contract plan.

In a “tallying model” the usage is kept as a running total, by each possible call type. Each time a call is made, the system increments the counter for that type (i.e. one of #Local, #Dom or #Intl will be incremented) and the total number of seconds for that call will be added to the running total for that call type (i.e. the corresponding Σ Secs for that type will have the duration of that call added to it).

| Date- | | Dura- | # | Σ | # | Σ | # | Σ |
|---|---|---|---|---|---|---|---|---|
| time | Type | tion | Local | Secs | Dom | Secs | Intl | Secs |
| 10 Mar. 2005 | Local | 10:20 | 1 | 620 | | | | |
| 11:52 | | | | | | | | |
| 12 Mar. 2005 | Local | 5:10 | 2 | 930 | | | | |
| 13:15 | | | | | | | | |
| 14 Mar. 2005 | Intl | 6:30 | | | | | 1 | 390 |
| 17:05 | | | | | | | | |

An important aspect of this technique is that the tally values are never reset. The number of calls made and the sum duration by type are tallied indefinitely. With this technique a monthly phone bill is calculated as the difference between the tallies at the beginning and the end of the month. This is an example of one processing approach. There may be others.

### 5.1.5 Overview of Approach

The objective of the stream-oriented database machine in preferred embodiments is to write an event stream to a set of storage-devices while continuously indexing, tallying and summarizing the data contained in the event stream. The following discussion progressively describes how a machine can be created which achieves this objective.

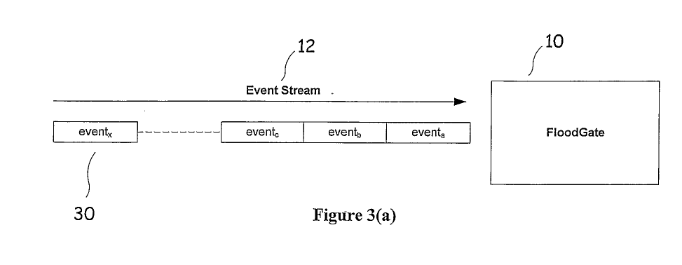

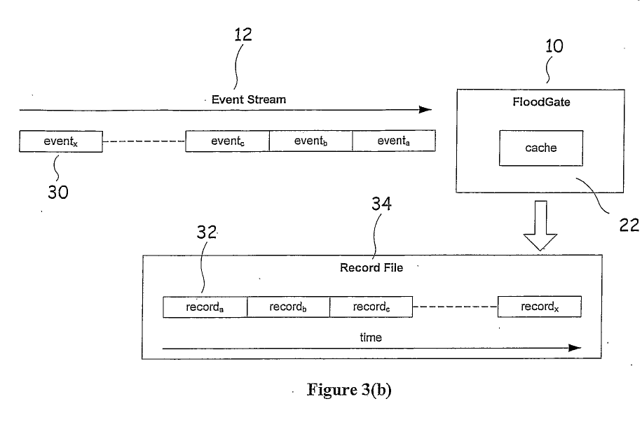

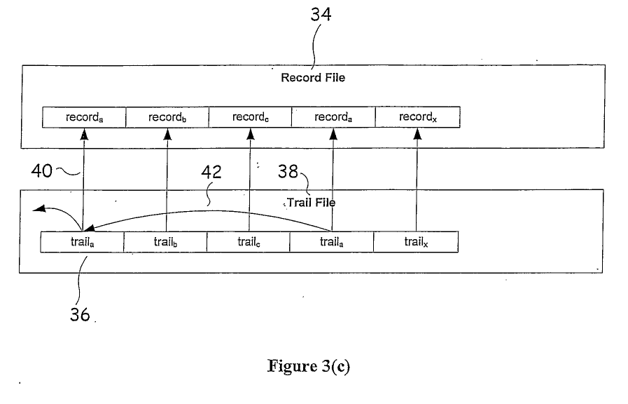

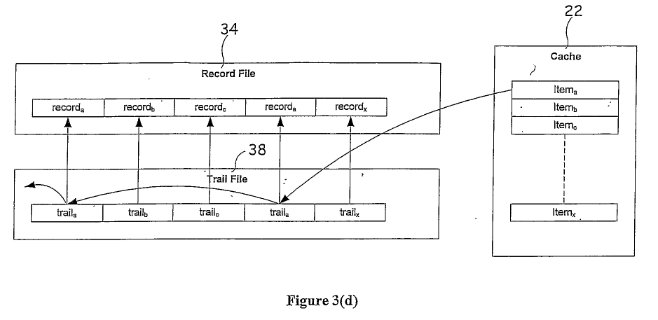

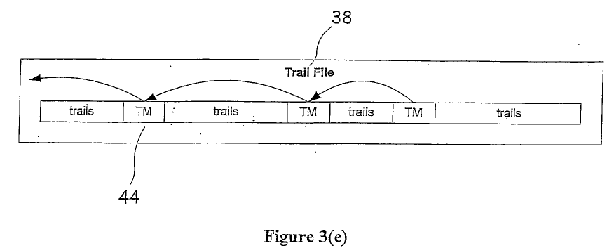

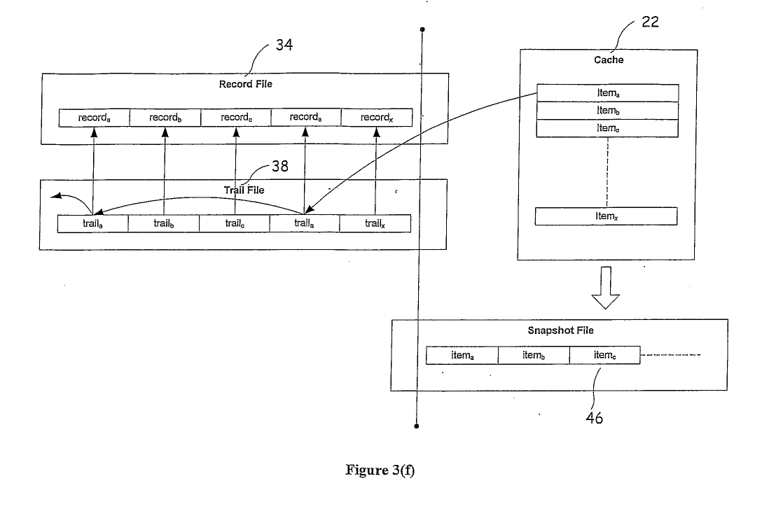

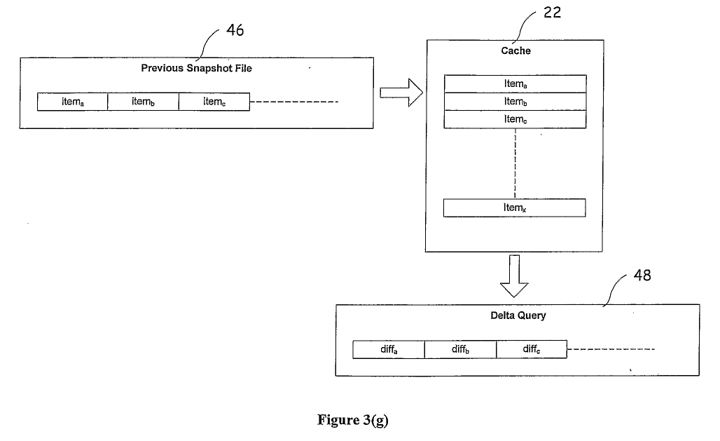

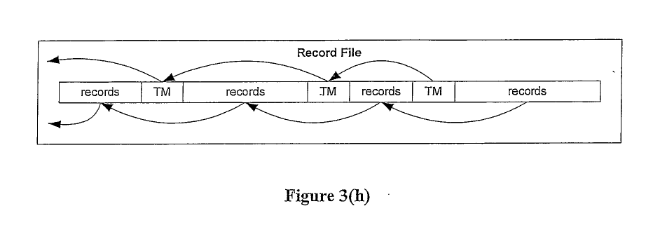

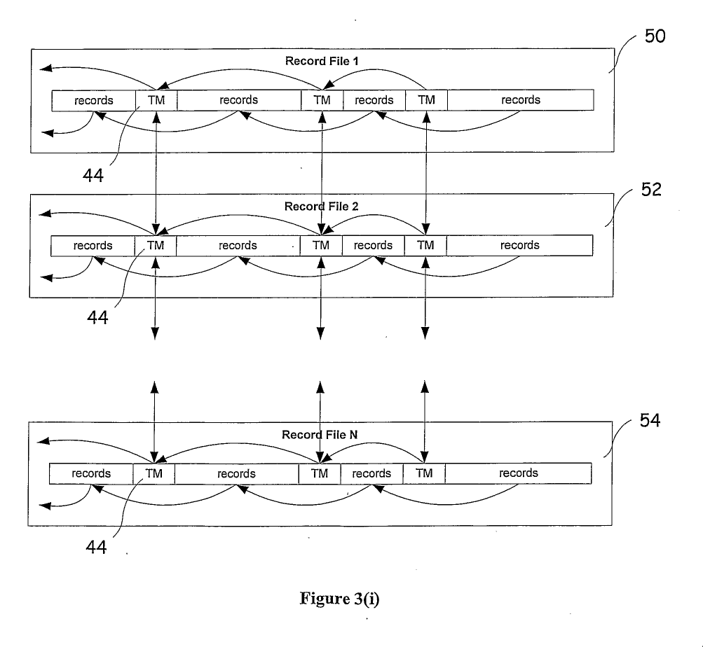

Referring to FIG. 3(a), an example event stream 12 is a continuous sequence of messages, pertaining to how a real-world object was (just) used. A discrete event 30 appears in the event stream each time such usage occurs so that it forms an accurate history of the events which may be processed, stored, replayed or queried at will. Events of this type will typically contain four pieces of information:
The identify of the object used;
When it was used;
Where it is was used; and
How it was used.

There may be additional information in the event message which may be of additional interest.

A basic requirement of the machine is to log the event stream so it can be forwarded, replayed or queried. Consequently, as events are ingested by the machine, a record of those events is written to persistent storage.

In FIG. 3(b) records 32 of the events are written to disk. The records are written in time sequence order to the record file 34. In parallel to this activity of writing records, and as shown in FIG. 3(c) the system also writes an entry 36 about each record into a separate file called a Trail File 38. This entry is called a Trail Marker. As shown in FIG. 3(c), each trail marker has a reference 40 to its corresponding record in the record file, as well as a reference 42 to the previous trail marker which relates to the same object. Trail markers effectively chain records pertaining to the same item backwards through time.

The system is able to write such backwards chaining trail markers because it keeps a reference to the last trail marker for each tracked object in question, in area in memory called the Cache 22, as shown in FIG. 3(d). This cache 22 also keeps running tallies, known as items, for each of the tracked objects. Each event processed by the system effectively changes the item in question. The new tally position is written within the record to the record file. Note that a modern 64 bit machine can keep in the order of a 100 million items in 32 GB of memory.

On a regular basis (typically once per second) a system record, called a Time Marker 44, is written to trail files as well. As shown in FIG. 3(e), a single time marker 44 appears between two sets of trail markers 36.

Time markers 44 contain references to previous time markers. The time markers form a time index (a chronologically ordered ruler stretching backwards in time) within the trail file. This enables the system to efficiently search backwards in time through the file, by skipping along the time markers. Note that a time marker entry is actually a set of references, such as a reference to the time marker of the previous second, minute, hour and day.

Periodically the system writes the contents of the cache to a file called the Snapshot File 46, see FIG. 3(f). This serves two purposes. It provides a regular, periodic summary of the system, which can be used for query and reporting purposes. And secondly, the snapshot file 46 can be reloaded into memory, providing the basis for a quick and accurate restart after a shutdown or machine failure. This approach described supports a number of different types of queries:
Stream Query—an interval of the event stream can be replayed by first searching backwards in time along the time markers to find the start point, and then reading the records and forwarding them to the requester until the end point is reached. Using a similar technique, an interval of a stream can also be played backwards;
Snapshot Query—a snapshot of the system can be taken (or a previous one read from disk) and forwarded to the query requester;
Delta Query 48—the difference between two snapshots (or the current position of the system and a previous snapshot) can be calculated and the results forwarded, see FIG. 3(g);
Item Query—the current state of an item can be taken directly from the cache and forwarded to the requester; and
History Query—a full history of an item can be can be forwarded to the requester by skipping backwards along the trail markers for the item in question.

There may be other types of queries capable of being supported by this approach.

To process a delta query 48, a previous snapshot file is read and the contents iteratively compared to the current tallies held in the cache for each item. The difference of the two positions can then be calculated to produce a delta or report file.

In summary the benefits of this approach are:
The event records are written to disk in a streaming manner, thereby maximizing disk utilization;
The events records are written largely as is, thereby directly enabling streaming replay with minimal overheads;
The time marker arrangement readily enables the system to rapidly search through the time index and establish the location of events at particular points in time; and
Snapshots enable the system to be summarized at regular intervals, and provide the basis for quick restarts and delta reports.

### 5.1.6 Possible Optimization

One possible optimization is to put the trail and time markers into the record file, as shown in FIG. 3(h). By doing this we alter the I/O mix. A system, for example, which has five drives allocated for record files and five drives allocated for trail files, could be reconfigured with ten drives allocated for record files.

Note that this means any time based lookups require such I/O to be borne by all drives. However, the time markers may also be parallelized. That is, time markers in one file could also reference the correlating time marker is other files, as shown in FIG. 3(i) which has time markers 44 refer to the corresponding time markers in neighbouring files 50, 52 and 54. With this approach, a time based search may be conducted within one file, and the corresponding locations in other files may then be readily determined. This minimizes the I/O load required for searching for locations in multiple files.

### 5.1.7 System Architecture

The primary objective of the stream-oriented database machine is to maximize throughput. On a machine with multiple CPU's maximizing throughput equates to maximizing parallelism while minimizing lost time due to resource wait. The system is based on a multi-threaded pipelining model, where processing is divided into stages known as agents. Each agent performs a discrete part of the overall processing. Agents are considered to be logically separate. All agents, being multi-threaded, can in principle execute concurrently.

### 5.1.8 Architectural Qualities

For the purposes of this system, the following architectural qualities have influenced the design:
Robustness—internal arrangement should facilitate defect identification and removal, such that the system matures quickly, becoming relatively defect free in the shortest time possible;
Comprehensiveness—internals readily understood by intended audience;
Malleable—arrangement should be easily modifiable should a shift in requirements dictate so. Features should be relatively isolated thereby enabling new ones to be added and obsolete ones removed;
a Elegance—minimal number of concepts needed to support required functionality (parsimony); and
Efficiency—perform highest degree of work using least amount of energy.

### 5.1.9 Agent Model

In preferred forms the system utilises an agent model as its primary orientation. An agent model may maximize throughput while fully embracing the above architectural qualities.

For the purposes of this embodiment an agent is defined as: a processing unit which performs a discrete step of a task within the system.

Within the framework of an agent model, complex tasks are broken down into a series of steps, where each step is performed by a distinct agent. Once a step has been processed by an agent the task is then dispatched to another agent (where in some cases the agent may be same as the original). In this sense agents collaborate to perform the overall set of tasks required.

Agents may be loosely coupled. Tasks move from one agent to another agent as their processing progresses, but the sequence of agents that a task moves through its processing life is not necessarily determined a priori.

### 5.1.10 Architectural Features

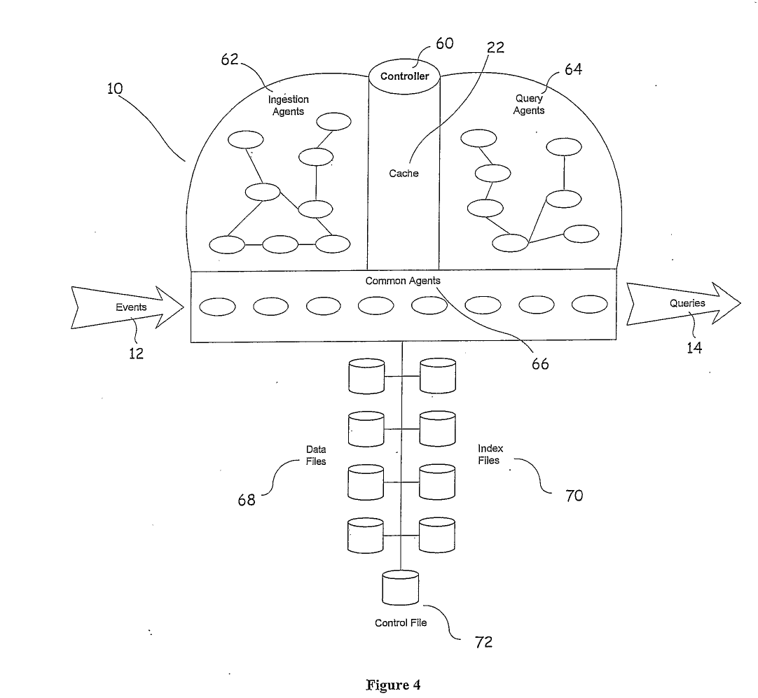

FIG. 4 shows a stylized depiction of the architecture of the stream-oriented database machine 10. The major features of this architecture are the:
Controller 60—an agent which is responsible for overall control in the system;
Cache 22—a shared memory structure;
Ingestion Agents 62—set of agents responsible for the ingestion of event streams;
Query Agents 64—set of agents responsible for servicing query requests;
Common Agents 66—set of agents which supply common base services;
Data Files 68—set of files which hold records of the ingested stream;
Index Files 70—set of files which hold trail and snapshot files; and
Control File 72—a file which records the current state of the system and contains enough discovery information to restart the system after a shutdown or failure.

### 5.1.11 Events

The purpose of the machine of this embodiment is to track usage of real world objects. Such usage generates an event which is transmitted as messages to the machine. Examples of such events may include, the object

Moved into a location;
a Moved out of a location;
Was put inside another object;
Was removed from some object;
Was used;
Had a particular temperature reading;
Was turned on; and
Was turned off.

### 5.1.12 Agent Internals

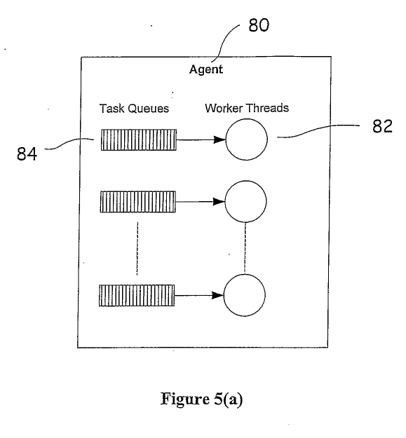

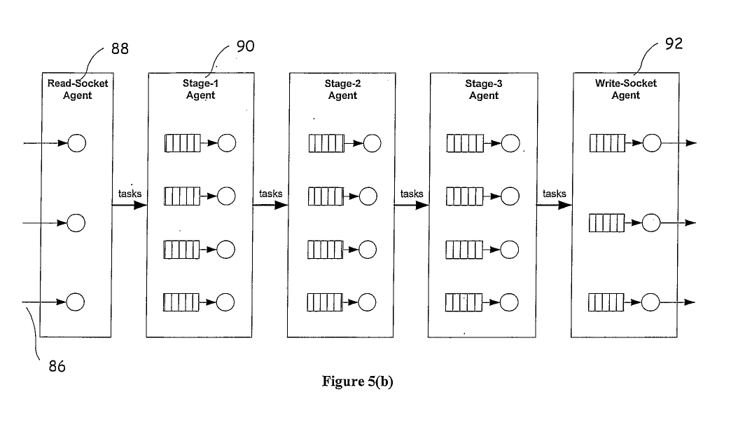

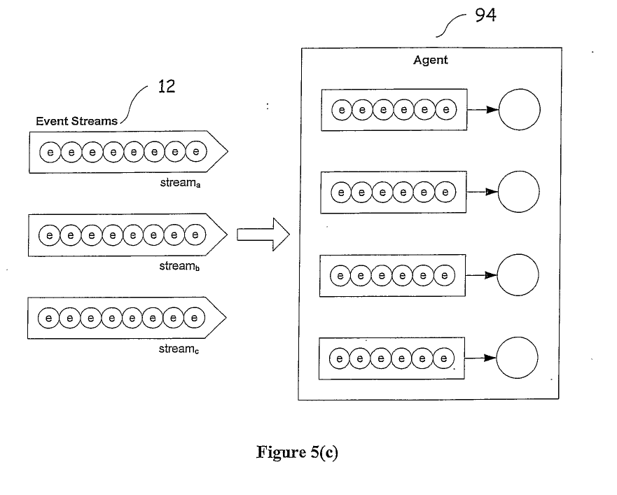

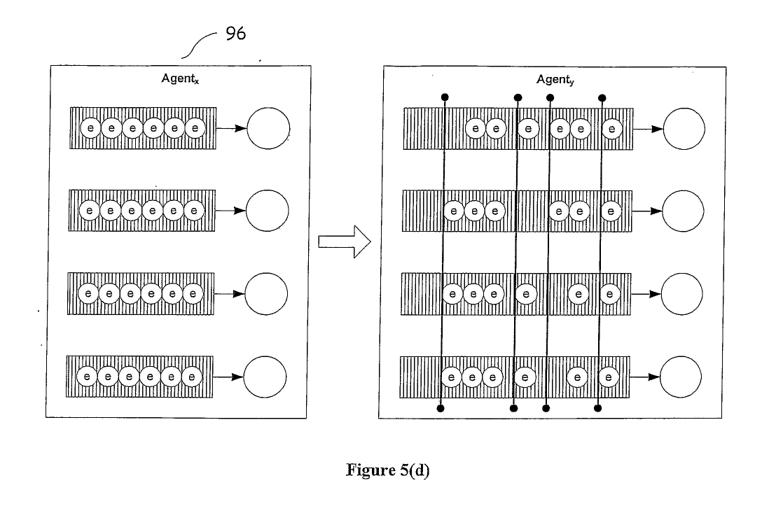

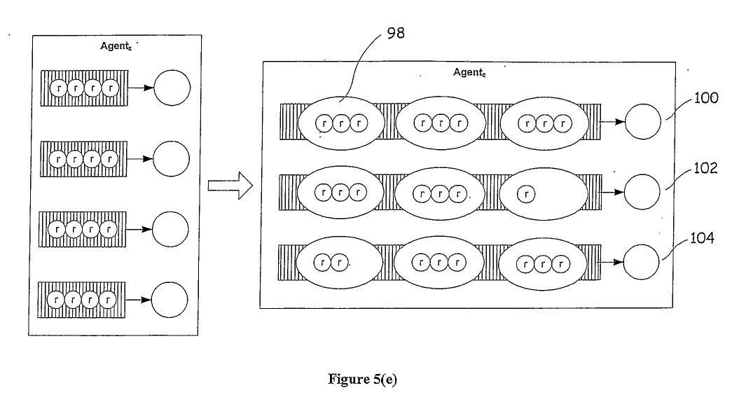

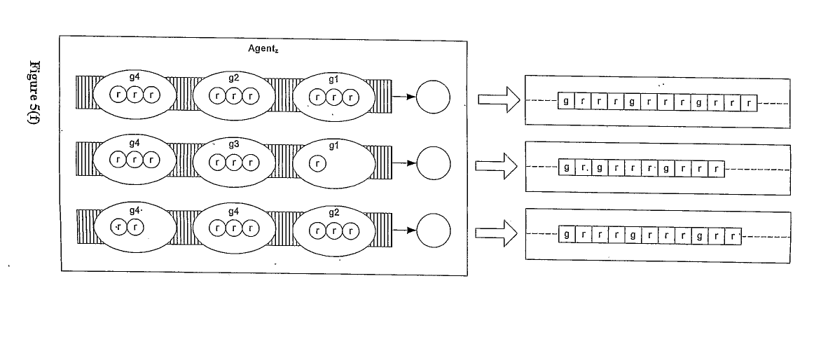

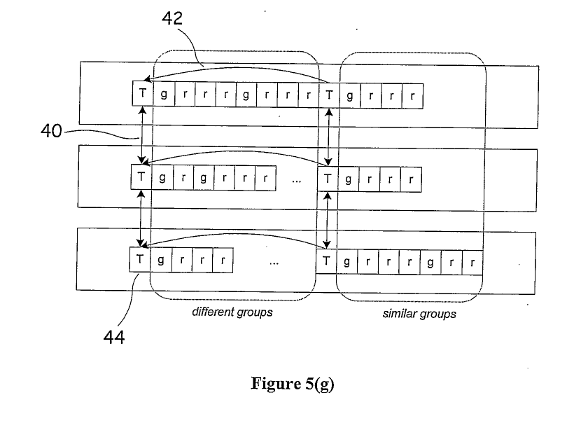

As shown in FIG. 5(a) agents 80 are a set of worker threads 82, where each worker thread 82 services a distinct queue 84. In this arrangement a task which is handed to an agent is put onto one of the task queues. The worker thread associated with that queue will eventually remove the task from that queue and process it. The benefits of this arrangement are:
Parallelism—on a multi-CPU machine an appropriate number of worker threads (and associated queues) can be created, thereby enabling multiple tasks to be performed in parallel;
Scalability—as resources (CPU and disks) are added to the model more concurrent work can be achieved; and
Load Balancing—the act of adding a task to a queue can take queue lengths into account. By adding tasks to the shortest queue work loads can be balanced over time.

### 5.1.13 Tasks

A task is a distinct unit of work to be performed by the system. A multi-tasking system is a system capable of handling multiple tasks simultaneously. This system is a multi-tasking system where tasks are created within the system in response to messages 86 received from sockets. A message is read from a socket by a read-socket agent 88 that uses the data in the message to create a task. The task is then handed to an appropriate agent 90 for processing. Eventually such tasks are typically handed to an agent 92 that transmits the result of the task as an acknowledgement message back along the socket to the originator of the message which first created the task. The task is then destroyed.

### 5.1.14 Task Pipelining

The practical upshot of the multi-threaded agent model as described above is task pipelining. Within the system there will be any number of tasks—many of them similar to each other. With task pipelining the tasks in the system at any one moment can be staggered through the various agents, with many of the agents potentially servicing multiple tasks in parallel.

FIG. 5(b) shows an abstract representation of the pipeline model of the system. Pipelining work in this manner affords a number of benefits over a model which process work as single steps:
Efficiency—in some cases work can be grouped together, such that some cost of the processing can be ameliorated over the group. Groups can be batched based on number of units, size, quantity or time;
Throughput—if a task is waiting on a resource, it does not hold up other tasks; and
Evenness—minor variations in processing time tend to spread over a larger number of tasks.

Pipelining also helps isolate locking and helps with the debugging process, particularly in identifying and resolving deadlocks. To facilitate debugging, agents can be put into a mode where tasks are single stepped through the system.

Additionally, during construction dummy or surrogate agents can be substituted for the real ones, thereby simplifying the development context. For example, the socket agents can be substituted with agents which simulate other machines, artificially generating event and query streams.

### 5.1.15 Stream Regulation

The machine accepts an indefinite number of incoming streams of events. Events within anyone given stream will be in chronological order. However the number of events per unit time will likely vary across streams.

In some cases it may be particularly important that a later event does not get processed before an earlier event. Let us assume for example, that we have three events streams 12 as depicted in FIG. 5(c). In this diagram there are events (e) arriving at the machine. Earlier events in time are process chronologically before later events. There may be more events pertaining to a given point in time in one particular stream versus another. Additionally there may not be events pertaining to all points in time, yet alone events pertaining to all points in time in all streams.

Therefore there may be an agent 94 in the system whose role is to regulate the incoming streams and ensure those events are evenly distributed to worker threads for processing in chronological order. This is referred to as stream regulation.

Alternative embodiments may not have or require stream regulation.

### 5.1.16 Event Processing

Having accepted and potentially regulated the incoming event streams, the next stage is to apply the events to the items held in the cache. FIG. 5(d) depicts an agent 96 applying the events and producing records. The event processing agent applies the events in their correct order, ensuring that later events are not processed before earlier events, and forwards them to the next stage.

### 5.1.17 Record Sets

The next stage is to prepare records so that they may be written to disk in an optimal manner and then later located and retrieved in an optimal manner. FIG. 5(e) shows records being collected into record sets 98, so that disk writing can be optimized.

As will be shown later, we are assuming the machine has three disk drives. Consequently collecting records into sets is being done along three lines 100, 102 and 104.

### 5.1.18 Record Groups

The next stage is to write groups of records in their correct sequence to a set of files. FIG. 5(f) shows record groups 106 being written in parallel to record files 108 on disk.

Groups have a sequence number recorded with them, primarily to be able to reconstruct the correct order of the records during query processing. From a physical perspective, observe that correlating record groups may be relatively staggered with respect to location within their corresponding files.

### 5.1.19 Time Markers

FIG. 5(g) depicts time markers 44 in the record files 108. In this example time markers appear in record files at one second intervals—if there have been records written to the files since the last time marker was written.

The diagram shows time markers 44 pointing backwards in time 42 to previous time markers, as well as pointing between neighbouring files 40 to contemporary time markers.

Observe that there may be a number of different record groups within an interval marked by two time markers, and there may a number of subsets pertaining to the same record group within an interval.

5.1.20 Performance

It is because of this approach that the machine may exhibit constant behaviour over time. Observe that the system only writes new information to disk. It never goes back and updates information in place.

By contrast relational databases (and other storage systems) typically use an indexing technique b-tree (short for balanced tree) to index every item which must be randomly retrieved. The b-tree indexing approach is a major contributing factor to why RDBMS technology is not suitable for streaming applications. Over time the b-tree indexes get larger and change shape. Consequently, not only are the disk drives used to randomly store and retrieve data, they are used to randomly store and retrieve sub-sections of the b-tree indexes as they are used and changed.

### 5.1.21 Cache

The stream-oriented database machine 10 keeps information about the most recent set of items in an area of memory called the Cache 22. Keeping such items primarily in memory (as opposed to reading or paging them in from disk) is a fundamental aspect of the machine's performance and throughput capability. The machine keeps the current state of a finite number of items in memory but an indefinite amount of history on disk.

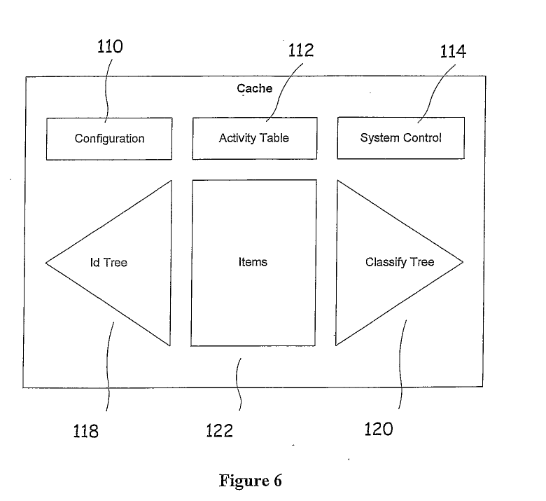

FIG. 6 depicts the Cache comprising of five components. The components of the cache are:
Configuration 110—information about the various options and settings;
Activity Table 112—data structure used to schedule query steps and handle overlaps;
System Control 114—information used to control the internal state of the system;
Items 116—a set of memory regions (program objects) which record the current state of real-world objects. There is one item for each real-world object currently being tracked;
Id Tree 118—a structure which keeps item addresses, keyed by the identity of the tracked object. This enables the identity of an object to be translated into the memory address of its corresponding item. There is one entry in the Id Tree for each item currently in memory; and
Classify Tree 120—a structure which keeps item identities, keyed by category-location classification. There is one entry in the Classify Tree for each unique category-location being tracked.

### 5.1.22 Items

Each item 122 is uniquely identified by its identity number (for example a 128 bit key) and contains information about the:
Last event which occurred in relation to the item;
Time when the last event occurred;
Geographic location where the last event occurred;
Current classification grouping the item is in;
Next and previous members (if any) of the current classification group; and
Disk reference of the most recent history record.

### 5.1.23 Id Tree

The Id Tree is typically a balanced binary tree which enables the id of an item to be translated into a pointer to the item in memory.

There is one entry in the Id Tree for each actual item. There may be any number of real-world objects about which the system has no information about. In those cases there is no entry for such potential items.

### 5.1.24 Classify Tree

The Classify Tree is typically a balanced binary tree which enables a classification grouping to be translated in the set of items that are currently in that group.

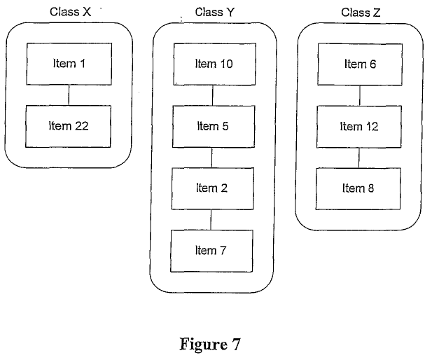

As shown in FIG. 7, items are grouped into their current classification. Each item contains the id of the next item within the same group.

Not all possible classification groups may actually exist at any given time. The Classify Tree only keeps information about those classification groups which are currently being tracked. There is no entry in the Classification Tree for classifications which are not currently being tracked.

An important property of the cache is that it can be read consistently by a scanning agent even though one or more other agents may be changing its contents. There are a number of multi-versioning techniques for providing read-consistency of such structures.

### 5.1.25 Definitions

In a preferred form the machine 10 requires some flexibility in being able to handle variations in message and item formats. The machine accepts definitions of items and messages and stores those definitions in its control file.

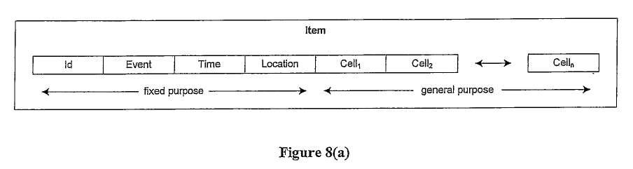

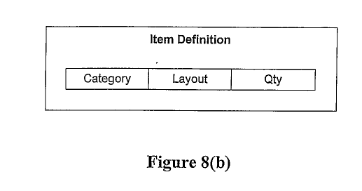

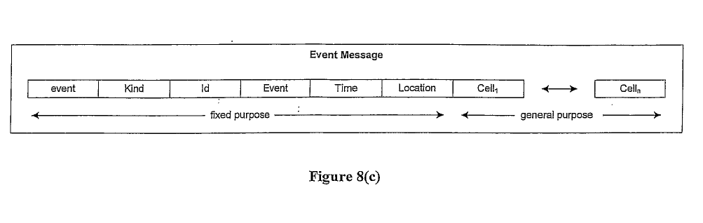

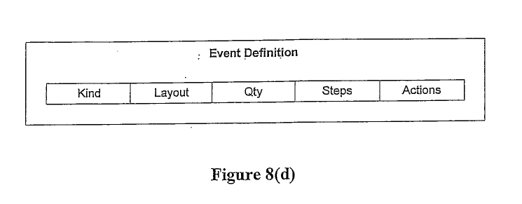

As shown in FIG. 8(a), an item is an array of cells of no particular length—much like a row in a spreadsheet. Some of the cells have fixed meanings, e.g. id, event, location, time. The remaining cells are available for general use. Cells can be used to keep tally values, mainly counts and summations. Alternatively, as shown in FIG. 61, an item can be a set of attribute-value pairs.

The actual layout of an item is defined by its Item Definition, depending upon its category; see FIG. 8(b). All items of the same category have the same layout. Basically the definition describes how cells are laid out, e.g. in singles, pair or triplets (see below), and how many there are.

Messages are also array of cells of no particular length—much like a row in a spreadsheet; see FIG. 8(c). Like that in items, some of the cells have fixed meanings, e.g. id, event, location, time. The remaining cells are available for general use.

The actual layout of a message is defined by its Message Definition, depending upon its kind; see FIG. 8(d).

All message of the same kind have the same layout. Basically the definition describes how cells are laid out, e.g. in singles, pair or triplets (see below), and how many there are.

Item or message cells values can be organized as an:
Singlets—an array of single values (either a count or a sum), identified by index;
Pairs—an array of paired values (a count and a sum), identified by index;
Coded—pairs of code and value (either a count or a sum), identified by code; and
Triplets—a trio of code, count and sum, identified by the code.

An event causes a series of actions to be executed. These actions include:
Put—put a message cell into an item cell (assignment);
Inc—increment item cell by 1 (running count); and
Add—add a message cell to an item cell (running tally).

Alternatively, actions could include complex formulae algorithmically encoded by a programmer.

### 5.1.26 Configuration

With reference to FIG. 6 the configuration section 110 of the cache holds the various changeable settings and options for the machine. This configuration information is loaded by the system at start-up time from a configuration file.

Such configuration information may include a restriction of the range of items—either by id or category—that the particular machine will hold; as well as system related information such as the number of operating system threads per agent or the number of storage-devices

### 5.1.27 System Control

With reference to FIG. 6 the system control section 114 of the cache holds the execution information for the system. This includes the definition for all long running queries. This information is also kept permanently on disk in the control file.

### 5.1.28 Activity Table

With reference to FIG. 6 the Activity Table 112 is used to correlate record sets with stream queries in order to schedule I/O and query processing. The Activity Table retains record sets in memory if they are of use to an executing query. The Record Sets are kept in time order, so that a query may use those record sets instead of performing I/O.

Likewise, stream queries are kept in the activity table in progress time order—i.e. time wise—where the query is up to. I/O is scheduled to read records sets back into memory in order to satisfy queries. This optimizes two important situations:
Multiple Query Overlap—multiple similar queries overlap—i.e. the same record sets would be used satisfy more than one query; and
Long Running Queries—when recently ingested events are immediately useful for long-running queries.

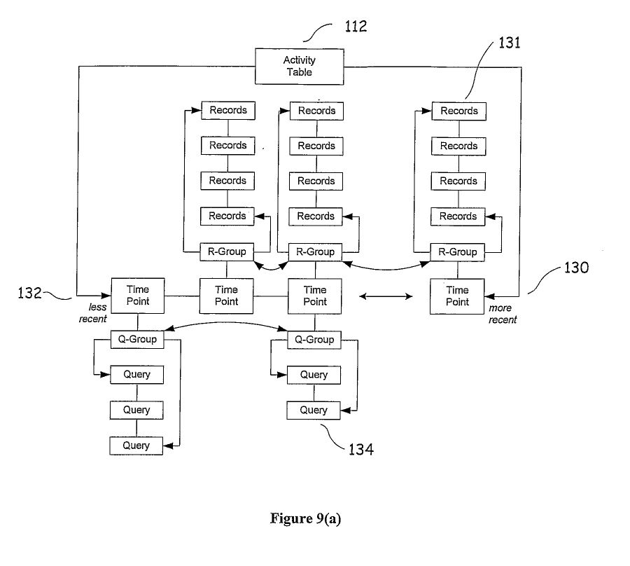

FIG. 9(a) shows a stylization of the activity table. Events occur at some discrete point in time and are sequenced. As events are processed they produce groups of record sets. These records sets are added to the activity table on the right hand side—time wise this is the leading edge. Record set groups 131 are removed from the left hand side 132 of activity buffer—time wise this is the trailing edge—when there are no more potential queries about those sets.

Stream queries 134 are added into the table as at their starting point in time. If there is no specific time point object representing that point in time, a time point object is created and inserted accordingly. If the query can be satisfied from records sets at that time point, then the query processing continues. Otherwise an I/O activity is scheduled.

When all the I/O activity for reading the record sets back into memory for that time point has completed, the time point “fires” and allows the pending queries for that time point to be processed. Queries then move to the next time point.

This repeats until the query has been satisfied. As query steps are processed the queries are shifted forward (to the right) onto the next time point. New time points are created and record sets reloaded if required.

Intervening record set groups may be pruned, and their associated time points deleted, if there are too many record set groups in the activity buffer.

This arrangement also supports read-ahead, where record groups can be read back in to memory in anticipation of use.

### 5.1.29 Time Line Variation

FIG. 9(b) depicts a variation of the Activity Table concept. In this variation there is an additional structure called the Time Line 136. Given there is sufficient memory in the machine, it may be feasible to hold all time points in memory. Time points would hold the reference location of the starting positions for each time point. As time passed old time markers could be discarded.

This arrangement resolves the tension between time, events, ingestion and queries.

For example, 30 days of time points taken each second, where the time point was a 160 byte structure, would occupy fewer than 400 MB.

Alternatively, a series of time points could be collapsed or expanded as required—two adjacent minute level time points represent the 59 collapsed second level time points between the minute points, while two adjacent day level time points would represent the 23 collapsed hour level time points, the 1416 collapsed minute time points and the 83544 collapsed second level time points. Any of these sequences could be partially or fully expanded as required.

### 5.1.30 Agents

With reference to FIG. 5(a) the stream-oriented database machine 10 uses agents 80 to create a multi-threaded pipelined model aimed at maximizing throughput. This includes agents for ingesting event streams, querying those streams as well as agents for performing socket and file I/O.

### 5.1.30.1 Controller Agent

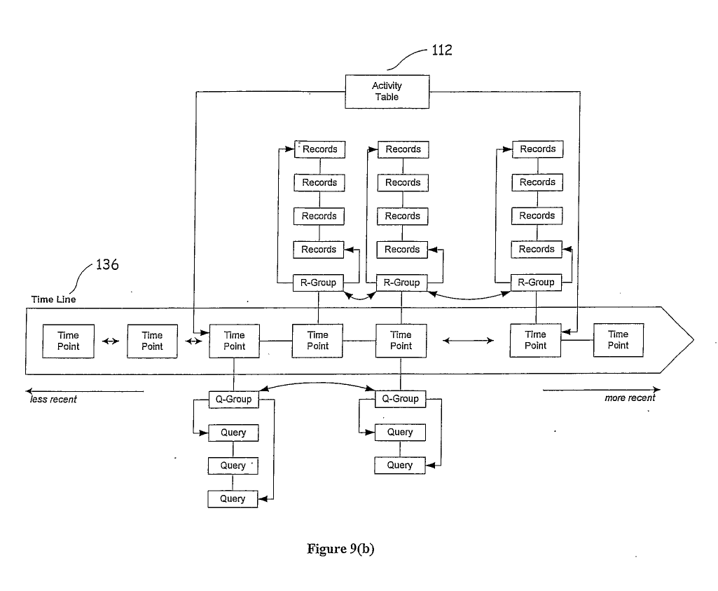

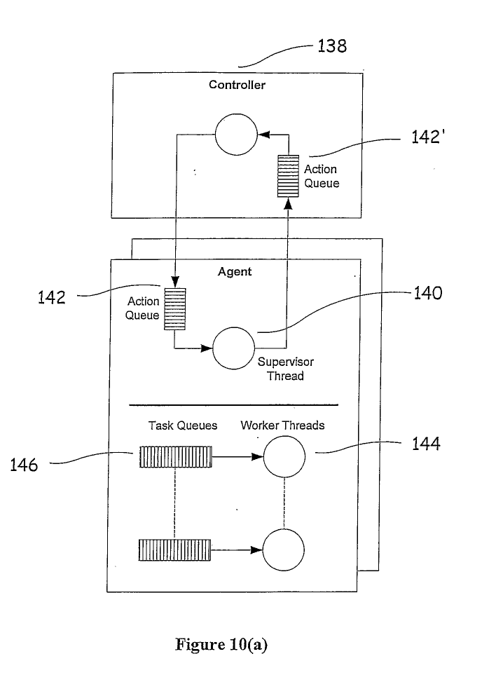

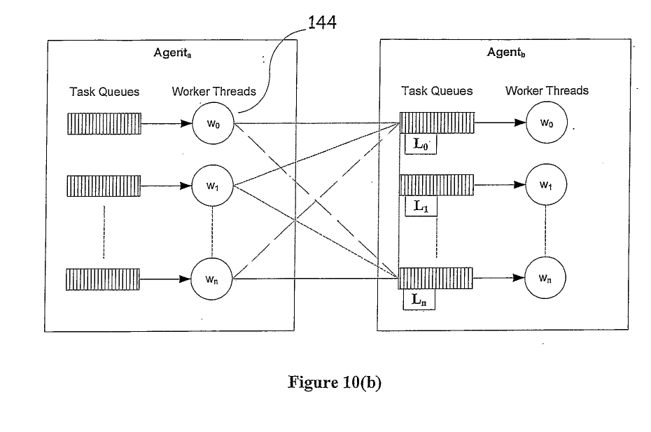

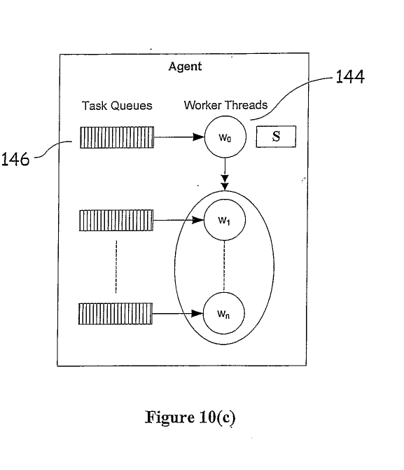

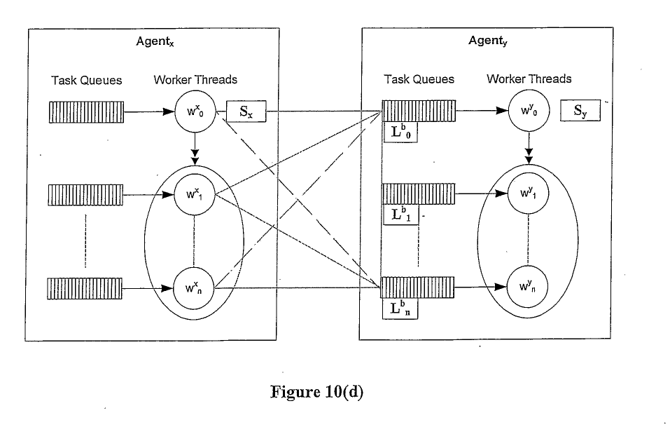

The stream-oriented database machine is a multi-tasking system organized as a set of agents. With reference to FIG. 10(a) one of these agents—the Controller 138—is special in that it manages or controls the other agents 80 in the system. The responsibility for managing and coordinating the constituent set of agents is the responsibility of an agent called the Controller.

FIG. 10(a) shows the Controller and depicts its relationship to the other agents. The following aspects may be observed in this diagram:
Each agent has a thread known as the Supervisor 140;
Each agent has a queue known as the Action Queue 142;
The supervisor thread 140 of an agent services the action queue 142 of that agent;
When the controller 138 needs to interact with an agent 80, it puts an action object onto the action queue 142 of that agent;
The supervisor thread 140 detects the action object and processes it; and
Such processing may cause the supervisor thread 140 of the agent to output an action object on the action queue 142′ of the controller 138.

To clarify: the worker threads 144 within an agent only service their respective task queues 146, while the supervisor thread 140 of an agent services the action queue 142. The Controller 138 can start, pause and stop agents using this technique.

The Controller 138 is the only agent which knows directly about other agents 80—it knows about all agents. While other agents hand tasks between themselves the act of determining the next agent for a particular task and then handing that task onto that agent is hidden in a callback function within the task. This keeps the agents loosely coupled.

### 5.1.30.2 Load Balancing

One of the benefits of the agent approach may be the ability to perform load balancing. As tasks progress from one agent to another, it may be appropriate to spread tasks evenly over the worker threads of the recipient agent.

FIG. 10(b) shows a stylized depiction of load balancing. When a worker thread 144 is to put a task into a queue in the next agent, that worker thread can first examine the queue lengths of the queues in the next agent, and then places the task on the shortest queue. Over time this has the effect of balancing work load over the available worker threads.

### 5.1.30.3 Synchronized Behavior

Another benefit of the agent approach may be the ability to perform synchronized behaviour, where the worker threads are required to process their work in lock step with each other.

FIG. 10(c) shows synchronized behaviour is achieved. In this behavioural model, one of the worker threads (w₀) is considered the leader. This lead thread makes a decision about what is to be done next and records that decision in some state variable (S). The lead thread then notifies the other workers to perform that step. Once all the other workers have completed that step, they notify the lead that they have done so.

One important usage for this technique may be to regulate the flow of tasks through an agent. For example, the state variable S could (in part) describe some characteristic of the agents which are to be processed. The worker threads could identify their next task on their queue in order to determine of it should be processed within that step.

### 5.1.30.4 Parallel Batching

The load balancing and synchronized behaviour models may be combined to perform parallel batching. This enables a set of worker threads in one agent to collect tasks into batches and then evenly distribute those batches onto the task queues of the next agent. The intent is that the second agent processes all tasks in one batch before proceeding to process tasks in the next batch.

FIG. 10(d) shows how an agents (with multiple worker threads) may produce batches of tasks of roughly equal numbers for Agent_{y}. In this behavioral model, the worker threads of the first agent (Agentₓ) are working in synchronized mode. They process the set of tasks from their respective tasks queues, delimited by Sₓ. When they finish processing they place the task into the task queue of the next agent (Agent_{y}), examining the queue lengths {L^{b}} in order to balance the load.

Once the set of tasks delimited by Sₓ has been completed, the worker thread W^{x}₀ of Agentₓ resets the queue lengths {L^{b}} of Agent_{y} and then proceeds to its next step. Thus, the queue lengths {L^{b}} only represent the length of the last batch, not the entire queue.

### 5.1.30.5 Ingestion Agents

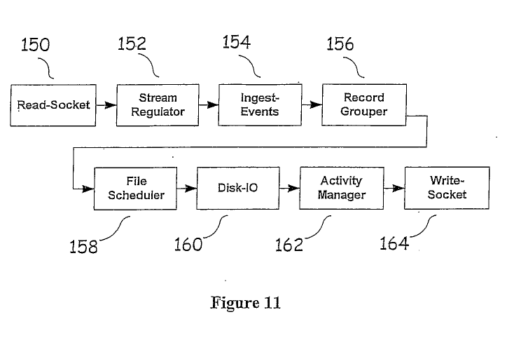

FIG. 11 depicts an example ingestion flow through the system. The following sequence occurs in this flow:
The Read-Socket agent 150 reads event messages from one or more sockets;
These messages are converted into event tasks;
These event tasks are then handed to the Stream-Regulator 152;
The Stream-Regulator 152 agent is responsible for examining the incoming event tasks and producing a load-balanced, time-ordered sequence of such tasks;
This time ordered sequence of tasks is handed to the Ingest-Events agent 154;
The Ingest-Events agent calculates the new tallies for the item and produces records;
The tasks with records of the events are handed to the Record-Grouper 156;
The Record-Grouper produces groups of record sets;
The record groups are handed to the Record-Grouper to the File Scheduler 158;
The File Scheduler creates an optimized schedule of file operations;
These file operations are forwarded to the Disk-IO 160 agent;
The Disk-IO then writes the appropriate entries into the record and trail files;
The tasks are then handed to the Activity-Manager 162;
The Activity manager inserts record groups into the activity table;
The tasks are then forwarded to the Write-Socket agent 164; and
The Write-Socket agent then sends messages back to the originator of the message, confirming the events processed.

### 5.1.30.6 Event Sequencing

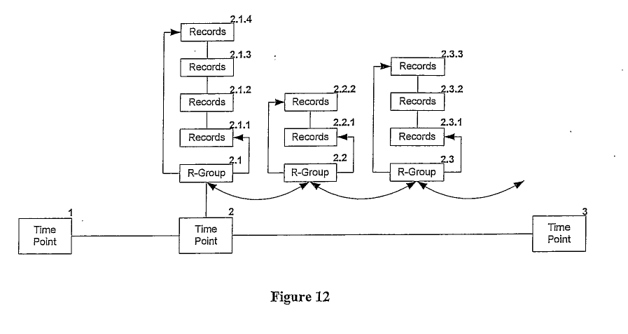

Events are hierarchically sequenced so they can be uniquely identified. Sequence numbers are also used to ensure that when event streams are replayed, the events are always replayed in the same order; see FIG. 12:
Time Points are numbered incrementally from 1-observe time points 1, 2 and 3;
Record Groups are numbered within time points—observe record groups 2.1, 2.2 and 2.3 are within time point 2;
Record Sets are numbered within record groups—observe record sets 2.1.1, 2.1.2, 2.1.3 and 2.1.4 are within record group 2.1; while records sets 2.3.1, 2.3.2 and 2.3.3 are within record group 2.3; and
Event Records (which are not shown in the diagram) would then be numbered within record sets, in a similar manner.

Events within a record group are considered to occur at, or about, the same time.

### 5.1.30.7 Query Processing

Queries largely fall into two categories:
Stream Queries—which are queries relating to a subset of all events between two time points; and
Item Queries—which are queries relating to individual items.

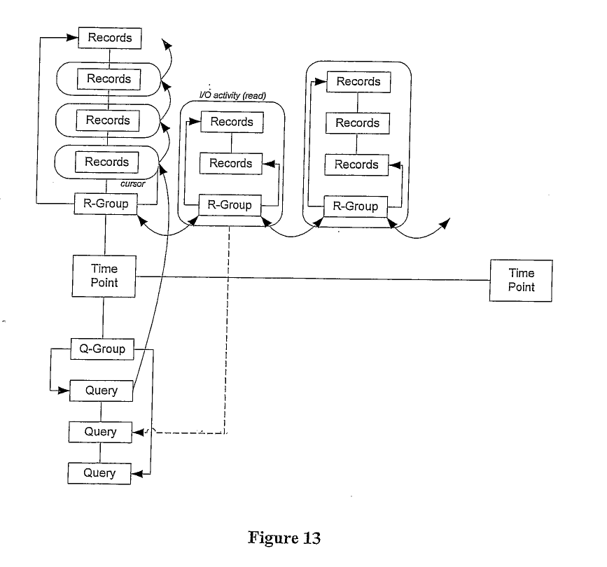

Stream queries, see FIG. 13, begin and end at some time point. If relevant record groups are not in memory, I/O activity is scheduled in order to reconstruct those record groups. As record groups are brought in to memory, this fires queries so they may progress to the next step. This may also fire new I/O activity.

Item queries pertain to the records of specific items. The first record of the queried item is read into memory. The reference to the previous record for that item is then used to read the previous record into memory. This sequence repeats until the required history of that item has been satisfied.

### 5.1.30.8 Query Agents

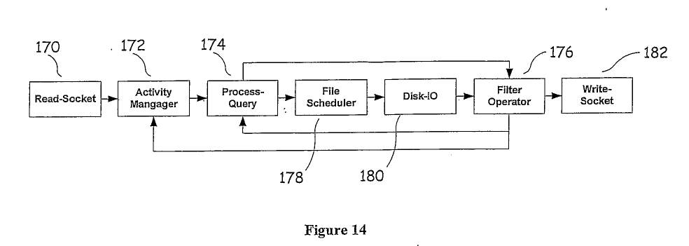

FIG. 14 depicts an example query flow through the system. The following sequence occurs in this flow:
The Read-Socket 170 agent reads query request messages from one or more sockets;
These messages are converted into query tasks;
These query tasks are then handed to the Activity-Manager 172;
The Activity-Manager inserts the query tasks into the activity table;
When a query task is to be executed the Activity-Manager forwards the task to the Process-Query agent 174;
The Process-Query agent 174 examines the query and determines how to satisfy the request. This typically involves preparing a query plan;
Depending on the how the query is to be satisfied, the Process-Query agent 174 may be capable of satisfying the query from the cache. In which case the task along with the result is handed directly to the Filter-Operator agent 176;
In the case where the query has to be satisfied by retrieving information from files the query task is handed to the File-Scheduler agent 178;
The File-Scheduler agent creates an optimized schedule of file operations;
These file operations are forwarded to the Disk-IO agent 180;
The Disk-IO agent then reads the appropriate entries from the record and trail files;
The task and the result is then forwarded to the Filter-Operator agent 176;
The Filter-Operator agent optionally filters data depending on the original request;
Any resulting data is then forwarded to the Write-Socket 182 agent;
If the query is a series of iterative steps the task is handed back to either the Process-Query 174 or the Activity-Manager 172 depending on whether the next step is to be executed immediately or some time in the future; and
The Socket-Out 182 agent then sends messages back to the originator of the message, supplying the results of the query.

### 5.1.30.9 Removal Process

After a query has processed the records for a time point, those records become candidates for removal—if it can be determined that those records are of no probable use to any other query.

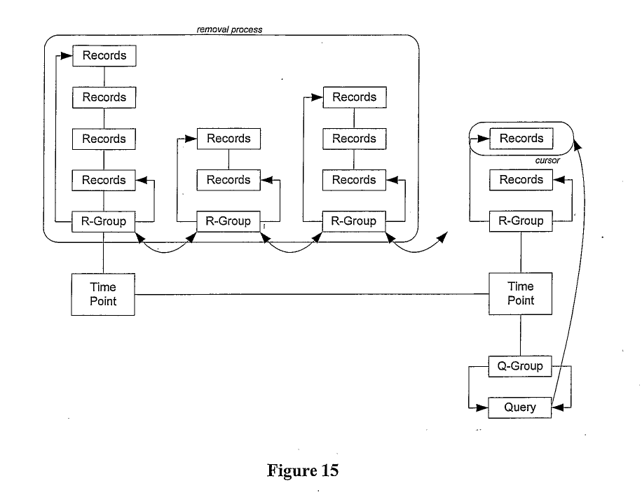

FIG. 15 shows a stylized example of a query moving onto its next time point, therefore leaving the records of the previous time point as candidates for removal.

Determining if the records pertaining to a time point are of probable use to another query is an interesting heuristic, which may need to balance time and space. Specifically, there will be a finite amount of memory in the machine available for buffering records against an indefinite number of queries. Consequently, a reasonable solution is to have an agent which periodically scans along the time line and removes records on a least-recently used basis. Alternatively, a more sophisticated solution is to remove records which appear to be of no immediate use—where immediate use is defined as a number of seconds calculated from a heuristic which considers the rate of ingestion, the number of queries and the amount of memory available for buffering.

### 5.1.30.10 Progress Markers

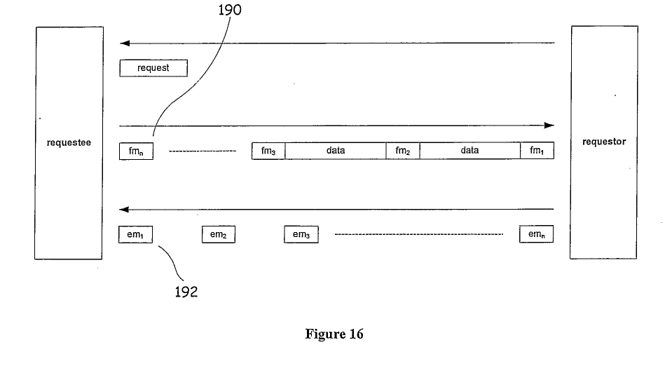

To ensure consistency and coherence of message transmissions between a requester and a requestee, progress markers are periodically issued between the parties. FIG. 16 depicts periodic markers, called flow markers 190, in a data/event stream being sent to the requester, and markers, called ebb markers 192, being sent periodically back to the requestee.

A flow marker may be sent every second, while an ebb marker is sent back in reply to each flow marker.

The machine uses the contents of these markers to resynchronize after a restart or failure.

### 5.1.30.11 Socket Agents

The machine uses agents to accept socket connections and to read and write messages to sockets. These agents treat messages as length-delimited sequence of bytes. The contents of the message are otherwise opaque to the agents.

### 5.1.30.12 File Agents

The machine uses agents to process I/O requests to files. These agents treat I/O operations as length-delimited sequence of bytes. File agents process requests which typically are to read or write bytes sequences at certain locations. The contents of the message are otherwise opaque to the agents.

### 5.1.30.13 File Scheduler

File I/O operations may arrive randomly within the system. Processing I/O requests in random order is known to produce sub-optimal disk performance.

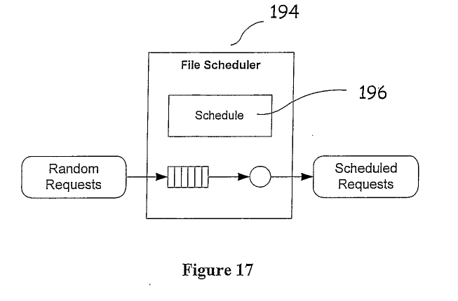

As shown in FIG. 17, the role of the agent known as the Request Scheduler 194 is to take a batch of I/O requests and sort them into a more optimal order. The Request Scheduler can be viewed as a pre-processor for the File Agent. A batch is delimited by a maximum number of bytes to be read or written, or by a maximum interval of time. Each I/O operation is simply put into a simple binary tree (known as the Schedule 196), with the tree ordered by the disk location where the request is to be performed.

Alternatively, a simpler embodiment could queue I/O requests and process them in a FIFO manner.

### 5.1.30.14 File Schedule

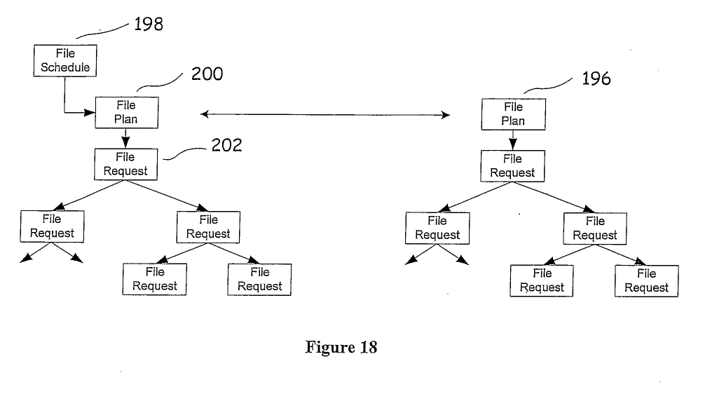

FIG. 18 depicts the File Schedule consisting of three components. The File Schedule 196 consists of:
File Schedule 198—top most object representing the file schedule 196;
File Plan 200—objects representing the set of requests currently being scheduled; and
File Request 202—objects representing a specific file read or write request.

### 5.1.30.15 File Operator

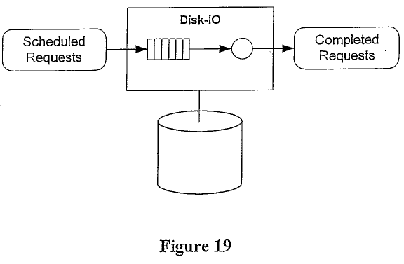

As shown in FIG. 19, the role of the File Agent is to take scheduled requests and process them.

### 5.1.30.16 Snapshot Agent

The Snapshot Agent is responsible for periodically taking a snapshot of the Cache and writing it to disk.

### 5.1.30.17 Command Agent

The Command agent is responsible for processing commands—instructions which alter the machine's behaviour. Commands include:
Start/stop/pause machine;
Add/alter/query/remove definition;
Add/alter/query/remove query;
Add/alter/query/remove machine; and
Change/query setting.

### 5.1.30.18 Reloader

The Reloader agent is responsible for reloading the cache after a restart.

### 5.1.31 Drive & File Management

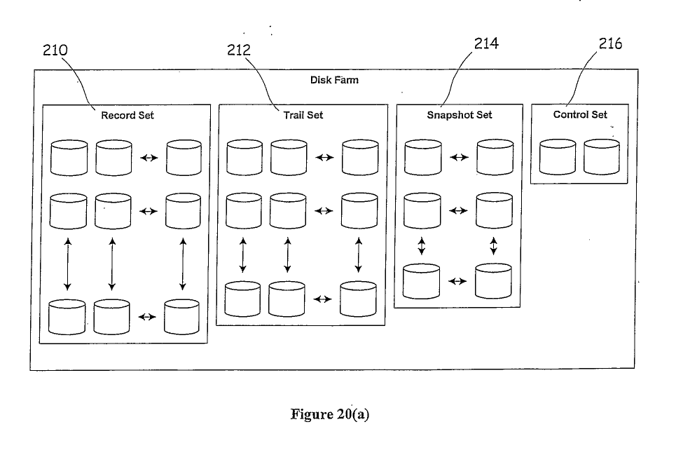

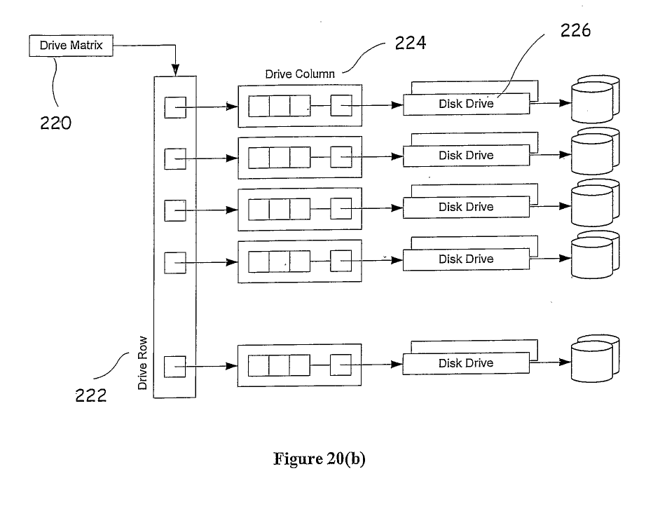

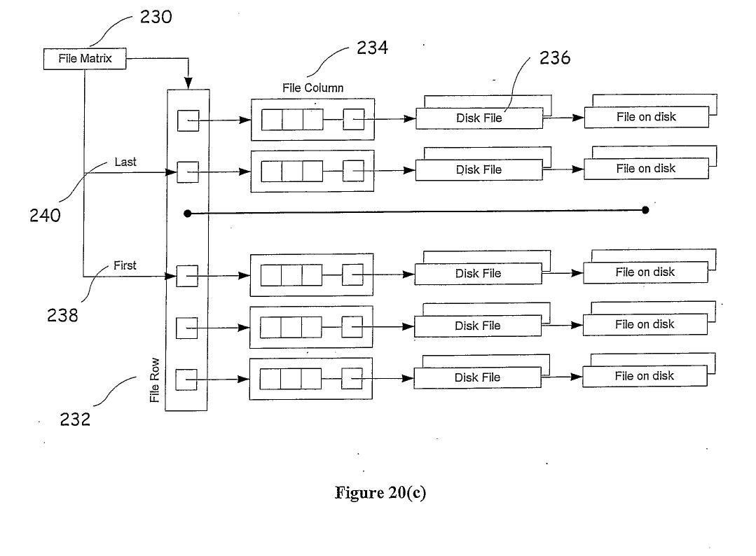

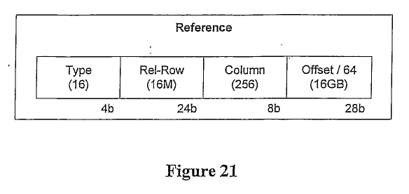

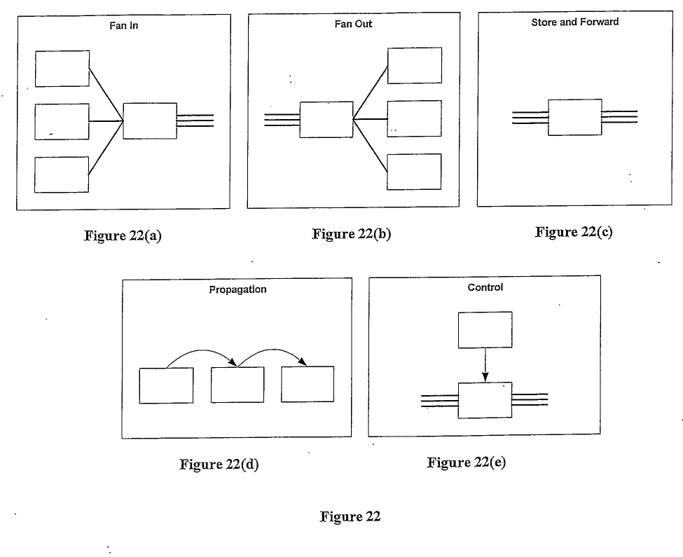

In preferred embodiments the machine 10 makes significant use of disk drives in order to store information—primarily event records, index trails, cache snapshots and system control files. As shown in FIG. 20(a) the disk farm may comprise of four sets of drives, each organized as a two dimensional matrix:
Record Set 210—the subset of drives which hold record files;
Trail Set 212—the subset of drives which hold trail files;
Snapshot Set 214—the subset of drives which hold snapshot files; and
Control Set 216—the subset of drives which hold control files.

Typically the drives are homogenous in that they are used to hold only one type of file. For example, drives in the record set only hold record files—and no other types. In turn, each drive holds a set of files. For example on a snapshot drive, there may be any number of individual files. A file does not necessarily occupy the entire drive.

Note that the number of disk drives is not necessarily the same in each set.

### 5.1.31.1 Drive Matrices

In order to manage the use of the disk connected to the machine, the system tracks each subset of the drives as a matrix. FIG. 20(b) depicts the matrix used for tracking the subset of drives which constitute the data set. Observe in this diagram that there is a:
Object called the Drive Matrix 220, which holds all of the information about the disk farm as a whole;
Vector called the Drive Row 222, which has an element for each row of disk drives in the subset;
Vector called the Drive Column 224, which has an element for each column of disk drives in the subset; and
Object called the Disk Drive 226, which holds all of the information about a particular disk drive in the subset.

Using matrices of this form allows disk drives to be accessed using row and column subscripts, while allowing an indefinite number of disk drives to be connected to the machine and managed in this manner.

### 5.1.31.2 File Matrices

In order to manage the set of files on the disk drives, the system tracks the files also using a matrix approach. FIG. 20(c) depicts the matrix used for tracking the files of a particular type. Observe in this diagram that there is a:
Object called the File Matrix 230, which holds all of the information about the matrix itself;
Vector called the File Row 232, which has an element for each row of files in the subset;
Vector called the File Column 234, which has an element for each column of files in the subset; and
Object called the Disk File 236, which holds all of the information about a particular file on a particular disk drive.

Additionally observe that the File Matrix holds two entries called First 238 and Last 240. Over time, new files are created and older ones are deleted. At any particular point in time the machine only retains a finite number of recently created files—the older ones have been deleted.

The File Row vector is of a finite size; with its particular size depending upon configuration. The File Row vector is a form of circular buffer, keeping the subset of known files between the element indicated by First and the element indicated by Last.

### 5.1.31.3 Entry Reference

Entries in a file often refer to other entries. This datum is called a Reference. The current system uses 64 bit references constructed in a manner which supports the matrix approach described above, although alternative representations could be used. As shown in FIG. 21 references are a four part bit sequence, which reflects the way in which disks are organized in the system. The Entry Reference consists of:
Type—which indicates if the reference is to an entry in a control, record, trail or snapshot file;
Row—the row number of the file;
Column—which column the file is in; and
Offset—the offset within the file where the entry is located.

The bottom most numbers (4b, 24b, 8b and 28b) indicate the length of each of the bit fields.

Note that row references are relative. References in files only point to entries in files which are in the same row of files, or rows previous to it. The Rel-Row entry is the number of rows previous the one where the entry is in.

A null reference is indicated by a null Type field.

### 5.1.31.4 Building Block Properties

In preferred embodiments the stream-oriented database machine is a machine which ingests, stores and indexes high-volume data event streams, and can respond to sophisticated queries.

The ability for one machine to query another machine and ingest the results has several important ‘building block’ properties which are illustrated in FIG. 22:
Fan In, FIG. 22(a)—the machine can be instructed to query a set of other machines and store the results—this is the primitive for funnelling data towards and into a central site;
Fan Out. FIG. 22(b)—queries can be about subsets of data—this is the primitive for data distribution;
Store and Forward, FIG. 22(c)—the machine has the ability to retain the data it ingests until such data has been queried by another machine—this is the primitive for store and forward;
Propagation, FIG. 22(d)—queries can be about definitions—this is the primitive for disseminating definition and control information; and
Control, FIG. 22(e)—the machine can be controlled and coordinated by another machine—this is basic primitive (when combined with the above) for clustering and failover.

It is the combination of these properties that enable multiple machines to be connected together in order to form highly reliable, real-time event collection and distribution networks of arbitrary size using low cost machines.

### 5.1.31.5 Long Running Queries

A feature of the machine is the support of long running queries. A long running query is of the form: fetch all items of category X from this time forward. Such a query is a request for future activity. Compare this to a database where a query is considered complete when the last relevant rows have been fetched, as per the last transaction which executed prior to the query being executed. Conventional queries relate to past activity, not the future. Using this feature one machine can post a long running query to one or more other machines. In this manner the original box collects/merges the streams ingested by the other machines.

Conversely, multiple machines can post long running queries to a single machine, requesting sub-sets of the future stream ingested by that machine. In this manner the later single machine can be seen as a distributor of events to other boxes.

Long running queries can be dynamically adjusted to broaden or restrict the subset of data which is to be returned.

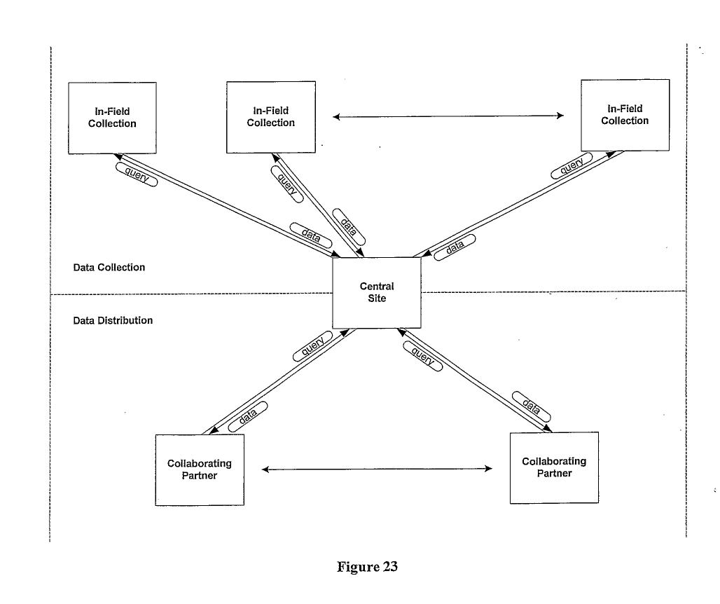

As depicted in FIG. 23, this feature enables multiple machines to be connected together to form highly reliable, real-time event collection and distribution networks of arbitrary size using low cost machines.

In this arrangement, from the perspective of the machine in the middle, the top half of the network can be seen as a data collection network, while bottom half can be seen as a data distribution network. The behaviors of all three types of machines are variants of the fundamental capabilities of the single presented design.

This machine can either be used as a supplemental machine logically coupled to database technology or as a standalone server for particular types of applications. Furthermore, multiple such machines can be connected together to create networks of arbitrary size which can collect and disseminate real-time data between any number of parties.

The availability of such a machine has significant implications for applications—particularly inventory and accounting. For example, computing the difference between any two summary positions indicates the work done during the interval.

Furthermore, the machine's ingestion and query capabilities have been designed in a manner which readily permits multiple machines to be connected together to form highly reliable, real-time event collection and distribution networks of arbitrary size using low cost machines.

This network capability would be of particular interest to groups of collaborating organizations who supply and use a myriad of products and services. Such a network would enable all parties to be aware of the location and usage of their products and services in real-time, in effect be continuously kept abreast of their collaborative positions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### 5.2 Detailed Description of the Second Preferred Embodiment

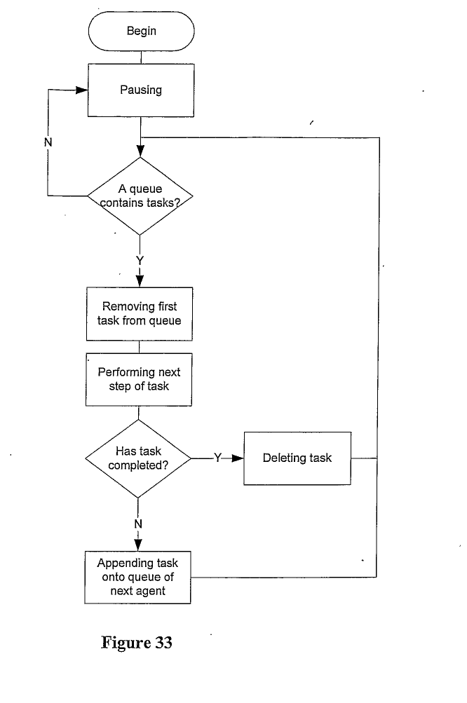

With reference to FIGS. 33 to 47 in a further preferred embodiment there is provided a:
Machine comprising one or more central processing units, one or more memory units, one or more disk units, one or more communication sockets, and a clock;
Such that the central processing units execute a number of threads, where:
   Each thread is said to belong to, or be within, one of a number of agents;
   Wherein each agent has one or more tasks queues containing a number of tasks;
   Which the agent, as shown in FIG. 33, is said to be performing in the following manner:
      Each thread within the agent is organized to service one or more of the task queues within said agent;
      Each thread is in a loop such that the thread first pauses briefly;
      Said thread then continues, testing if one of its said task queues contains one or more tasks;
      If there are no tasks in any of said task queues said thread pauses and repeats;
      Otherwise the thread continues, removing the first task from the first task queue which has tasks that the thread is servicing;
      Performing the next step of said first task;
      Testing if said first task has completed;
      Deleting said first task if it has completed;
      Otherwise appending said first task onto a task queue of the agent indicated by the contents of the task, whereupon said first task becomes the last task in that task queue; and
      The thread then continues by testing its task queues again.
Such that the memory units are a set of memory regions which contain data and can be transformed by threads; such memory regions are collectively known in the preferred embodiment as the cache, where said cache is divided into three sections:
   The item trees, where:
      In the preferred embodiment, each memory region within the item trees section of the cache is known as an item;
      Each item contains information about a physical, temporal or logical object that is external to the machine;
      Each item is identified by the identity of the external object it is said to represent;
      Each item may contain the identity of one or more other external objects which are known to be juxtaposed or associated in some physical, temporal or logical manner with the external object represented by said item;
      Each item may contain the identity of a location bin (see below) within which it is said to be;
      Each item may contain one or more references to disk records containing information that the item held previously in time;
      The memory address of all said items are collected into a data structure keyed by the identity of the external objects, such that supplied with the identity of an external object, the data structure can be searched by a thread in order to translate the identity of said external object into the memory address of the item containing the information about said external object;
      In the preferred embodiment, in order to maximize concurrency and reduce multi-threaded contention during such operations as insert or delete, the said data structure is an array of binary trees, where a specific binary tree is chosen based on a simple hash function of the external object identity, and then only that specific binary tree is locked during said operation;
   The location bins, where:
      A location bin is a data structure occupying one or more memory regions;
      A location bin represents an external physical, temporal or logical location;
      Each location bin is identified by the identity of the external location it is said to represent;
      A location bin is said to collect or group items which are known to be at said external location represented by said location bin;
      In the preferred embodiment, in order to maximize concurrency and reduce multi-threaded contention during such operations as insert or delete, said data structure collecting the items of one location is a set of lists, where a specific list is chosen based on a simple hash function of the external object identity, and then only that specific list is locked during said operation;
      In the preferred embodiment, the locations bins are collected into a binary tree, keyed by the external identity of the location;
   The timeline, where:
      The timeline is a data structure which is a collection of other data structures, known in the preferred embodiment as time points;
      Each time point represents a specific point in time, which in the preferred embodiment is down to the resolution of one second;
      Each time point holds a set of complex records, known in the preferred embodiment as a bucket;
      Each complex record is a set of records, where each record is information about an atomic change made to one or more said items;
      Organized such that buckets can be deleted or restored by an agent in the manner described below;
      A least-recently-used list is kept of the buckets currently in the timeline;
Such that the disk units are organized into a number of disk lines, such that each disk line contains one or more disk units;
Such that the communication sockets are monitored by an execution agent, known in the preferred embodiment as the Answer-Socket Agent, perpetually executing a task per communication socket, collectively known in the preferred embodiment as Answer-Socket Tasks;
Such that the clock indicates or measures the passing of time;

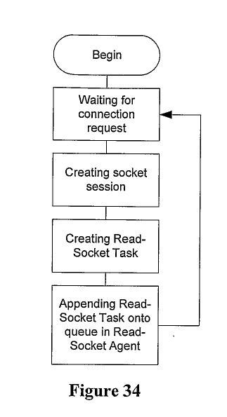

The Answer-Socket Agent, performing a Answer-Socket Task in the manner as shown in FIG. 34, executes by:
Waiting for a connection request from an external source;
Creating a socket session on the communication socket;
Creating a task, known in the preferred embodiment as a Read-Socket Task, and associating it with the socket session;
Appending the Read-Socket Task onto a task queue of an agent known in the preferred embodiment as the Read-Socket Agent; and
Continuing execution by repeating the above.

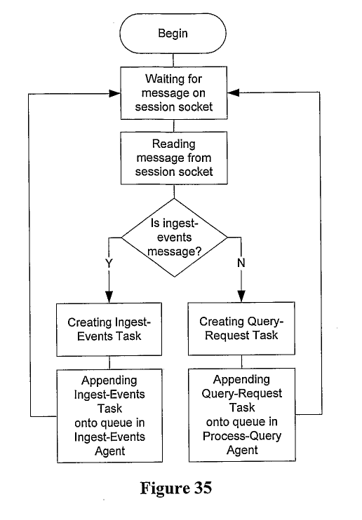

The Read-Socket Agent, performing a Read-Socket Task as shown in FIG. 35 in said manner, executes by:
Waiting for a message from an external source on a session socket;
Reading message from said session socket;
Testing said message, such that;
   If the message is an ingest-events message, continuing by:
   Creating a task, known in the preferred embodiment as the Ingest-Events Task, containing the ingest-events message received from the external source
   Appending said Ingest-Events Task onto a task queue of an agent known in the preferred embodiment as the Ingest-Events Agent;
Else continuing by:
   Creating a task, known in the preferred embodiment as a Query-Request Task, containing the query-request message received from the external source;
   Appending said Query-Request Task onto a task queue of an agent, known in the preferred embodiment as the Process-Query Agent; and
Continuing execution by repeating the above.

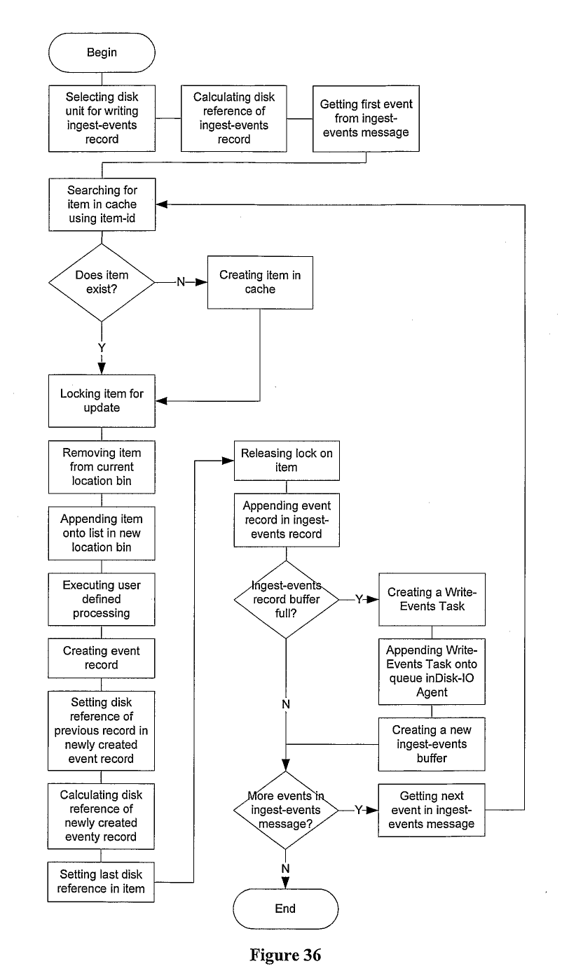

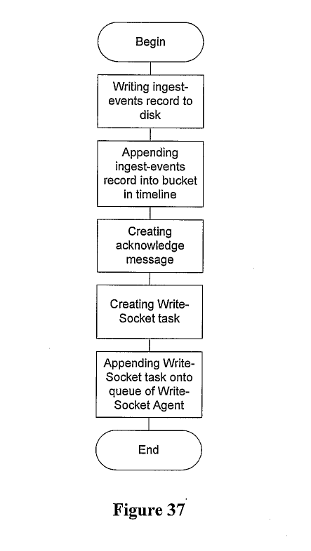

The Ingest-Events Agent, performing an Ingest-Events Task as shown in FIG. 36 in said manner, executes by:
Selecting a disk unit from a disk line to be used for recording an ingest-events record;
Calculating the disk reference the ingest-events record will have when finally written to disk;
Searching through the aforementioned cache using the identity of the first external object in the ingest-events message in order to discover the memory address of an item;
Creating the item if it does not currently exist in the cache;
Locking the item for update;
Removing the item from it's current location bin;
Appending the item to a new location bin;
Executing any user defined code;
Creating a record of the event;
Setting the disk reference of the previous event in newly created event record;
Calculating the disk reference of the newly created event record;
Updating the disk reference of the last known event record in said locked item;
Releasing lock on said item;
Appending event record in ingest-events record;
Testing if ingest-events record buffer is full, and if so:
   Creating a task known in the preferred embodiment as a Write-Events Task, containing the complex record;
   Appending said Write-Events Task onto the task queue of an agent known in the preferred embodiment as the Disk-IO Agent;
Testing if there are more events in the ingest-events message, and if so repeating the above sequence for all object identities in the ingest-events message;

Where the Disk-IO Agent, performing a Write-Events Task as shown in FIG. 37 in said manner, executes by:
Writing said ingest-events record onto the medium of said selected disk so as to be in temporal sequence with the other complex records already on that said disk;
Transforming said timeline so as to contain a copy of said ingest-events record in temporal sequence with other ingest-events records within the bucket of the same relevant time point;
Creating an acknowledgement message;
Creating a task, known in the preferred embodiment as a Write-Socket Task, which contains the acknowledgement message;
Queuing said Write-Socket Task onto a task queue of an agent known in the preferred embodiment as the Write-Socket Agent;

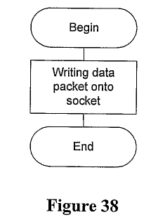

The Write-Socket Agent, performing a Write-Socket Task as shown in FIG. 38 in said manner, executes by transmitting the acknowledgement message back to the external source via said session socket.

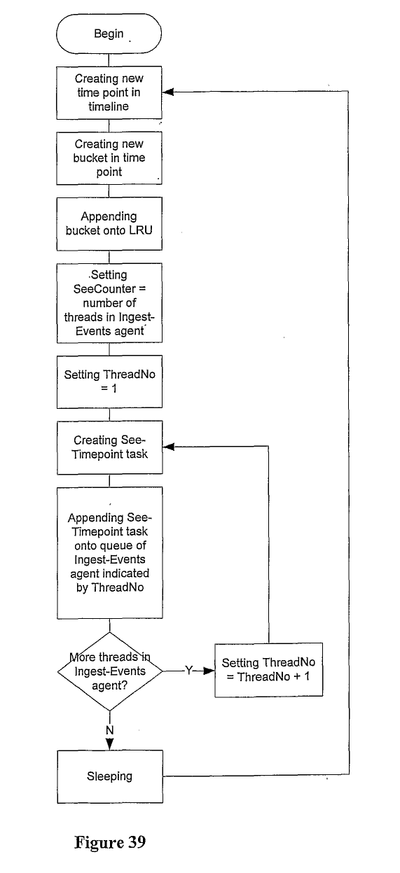

The machine periodically marks the passage of time by having an agent, known in the preferred embodiment as the Generate-Timepoint Agent, perpetually executing a task, known in the preferred embodiment as the Generate-Timepoint Task as shown in FIG. 39 in said manner. It executes by:
Creating a new time point containing the date and time read from the clock;
Creating a new bucket for the new time point;
Appending an entry about the bucket to the end of the least-recently used list of buckets within the timeline;
Setting an atomic counter, known as the SeeCounter, to be equal to the number of threads in the aforementioned Ingest-Events Agent;
Creating a set of tasks, each known in the preferred embodiment as a See-Timepoint Task, one such task for each thread in the Ingest-Events agents, wherein said See-Timepoint Task contains a reference to the new time point;
Queuing each See-Timepoint Task onto each relevant task queue of the aforementioned Ingest-Events Agent;
Sleeping for an interval of time, which in the preferred embodiment is one second; and
continuing execution by repeating the above.

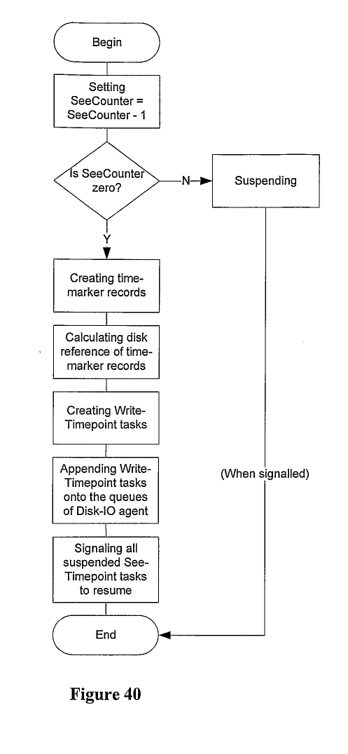

The Ingest-Events Agent, performing a See-Timepoint Task as shown in FIG. 40 in said manner, executes by:
a Decrementing the aforementioned SeeCounter;
Testing the result of the decrement;
If the result is non-zero the task is suspended, and upon resumption the task is deemed to be over;
Else the task continues by creating a record of time, known in the preferred embodiment as a time-marker, for each disk unit;
Calculating the disk reference that each record of time will have when finally written to disk;
Populating each record of time with the:
Date and time of day of said new time point;
Disk reference of one or more previous records of time for the disk unit the said record of time pertains to; and the
Disk reference of one or more records of time pertaining to the same said complex record of time;
a Creating a Write-Timepoint Task for each thread in the aforementioned Disk-IO agent;
Associating the relevant record of time with each of the created Write-Timepoint Tasks;
Queuing each Write-Timepoint Task onto each relevant task queue of the aforementioned Disk-IO Agent; and
Resuming all other suspended See-Timepoint tasks;

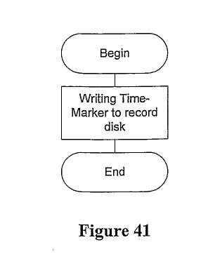

The Disk-IO Agent, performing a Write-Timepoint Task as shown in FIG. 41 in said manner, executes by transforming the disk unit identified in the said Write-Timepoint Task by writing the record of time onto the medium of said disk unit.

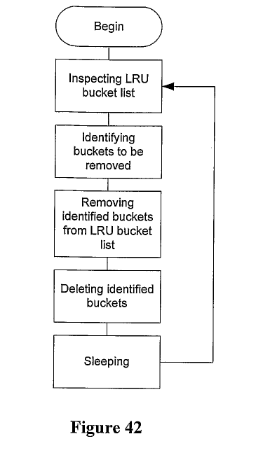

The machine periodically removes buckets from the timeline by having an agent, known, in the preferred embodiment as the Housekeeping Agent, perpetually executing a task, known in the preferred embodiment as the Purge-Timeline Task as shown in FIG. 42 in said manner. It executes by:
Inspecting the aforementioned least-recently-used list of buckets;
Identifying zero or more buckets at the top of the least-recently-used list to be removed;
Removing the reference to each identified bucket from the least-recently-used list;
Deleting each identified bucket from the timeline;
Sleeping for an interval of time; and
Continuing execution by repeating the above.

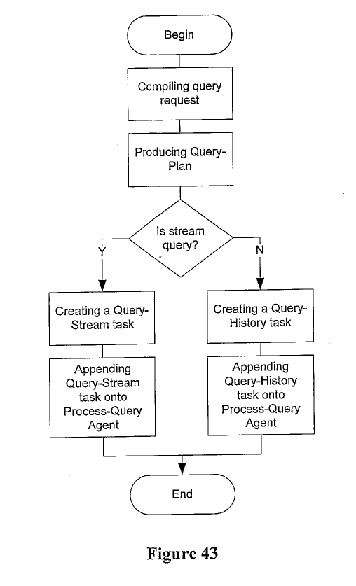

The Process-Query Agent, performing a Query-Request Task as shown in FIG. 43 in said manner, executes by:
Compiling the query-request message contained with the Query-Request Task;
Producing a sequence of further steps, known in the preferred embodiment as a query-plan;
Identifying the query-request either as one type of query, known in the preferred embodiment as a stream query, or a different type of query, known in the preferred embodiment as a history query;
If the query was identified as a stream query, the Process-Query Agent proceeds by:
   Creating a task, known in the preferred embodiment as a Query-Stream Task; and
   Queuing said Query-Stream Task onto a task queue of the Process-Query Agent;
Else if the query was identified as a history query, the Process-Query Agent proceeds by:
Creating a task, known in the preferred embodiment as a Query-History Task; and
Queuing said Query-History Task onto a task queue of the Process-Query Agent;

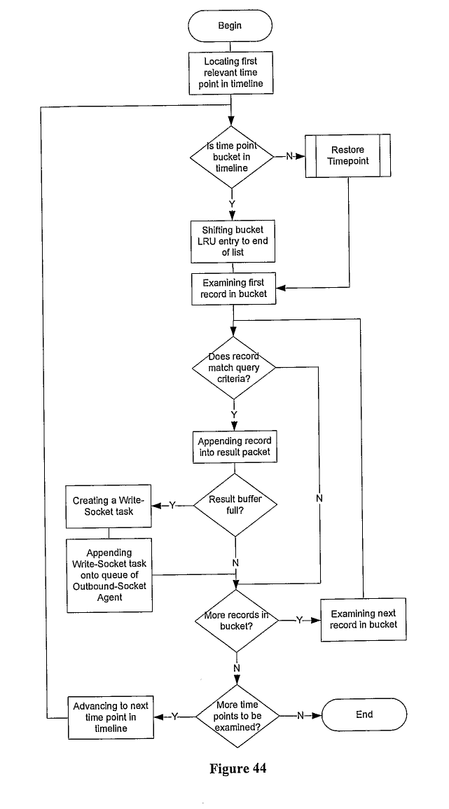

The Process-Query Agent, performing a Query-Stream Task as shown in FIG. 44 in said manner, executes by:
Creating a result buffer;
Locating the first relevant time point, as specified in the stream query-request, in said timeline;
Testing if the bucket exists at the time point, such that if the bucket does not exist at the time point, the bucket is first restored in the manner described below;
Shifting the entry in the least-recently-used list of buckets pertaining to bucket being examined to the end of said list;
Iteratively examining each record within each complex record within the bucket in turn;
Testing if the record matches the criteria specified in the stream query-request;
If the record matches the said criteria, the record is copied into a result buffer;
If the result buffer is full, the Process-Query Agent proceeds by:
   Creating a task, known in the preferred embodiment as a Write-Socket Task;
   Associating the full result buffer with said Write-Socket Task;
   Queuing said Write-Socket Task onto a task queue of the Outbound-Socket Agent; and
   Creating a new result buffer;
If there are no more records in the bucket the Process-Query Agent proceeds by advancing to the next time point;
If the time point is within the range specified by the said stream query-request the Process-Query Agent continues processing in the same aforementioned way;

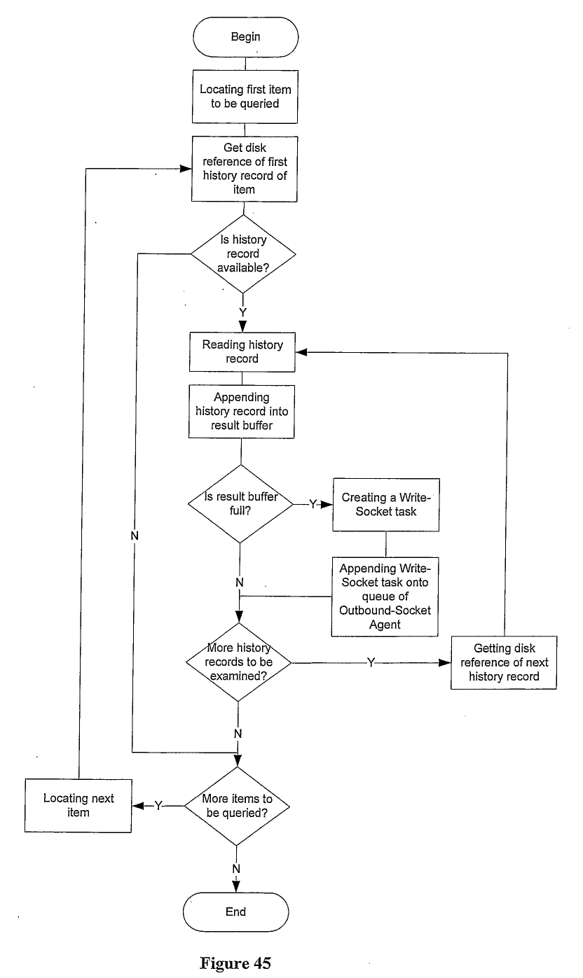

The Process-Query Agent, performing a Query-History Task as shown in FIG. 45 in said manner, executes using the object identities in the history query-request by:
Creating a result buffer;
Finding the item in the cache;
Extracting the disk reference of the most record from the item;
Reading the record from the referred disk unit;
Testing if the record meets any additional criteria specified by the history query-request;
Appending the record if it meets the said additional criteria into a result buffer;
Testing if the result buffer is full;
If the result buffer is full, the Process-Query Agent proceeds by:
   Creating a task known in the preferred embodiment as a Write-Socket Task;
   Associating the full result buffer with said Write-Socket Task;
   Queuing said Write-Socket Task onto a task queue of the Outbound-Socket Agent; and
   creating a new result buffer;
Extracting the disk reference of the previous record from the just read record;
If there is a disk reference to a previous record, to proceed by reading that record from disk and continue processing in the same aforementioned way; and
If there are no more previous records, the Process-Query Agent proceeds to process the next object identity in the history query in the above aforementioned way;

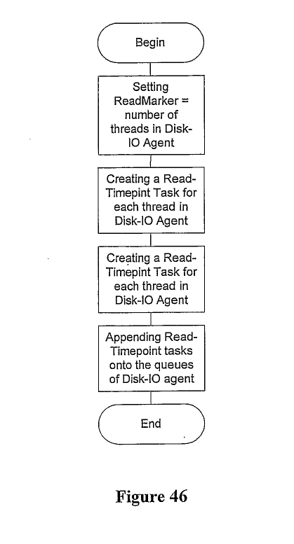

The Process-Query Agent, performing a Restore-Timepoint Task as shown in FIG. 46 in said manner, executes by:
Setting an atomic-counter, known in the preferred embodiment as ReadMarker, to the number of threads in the aforementioned Disk-IO agent;
Creating a Read-Timepoint Task for each thread in said Disk-IO agent; and
Queuing each Read-Timepoint Task onto each relevant task queue of the aforementioned Disk-IO Agent;

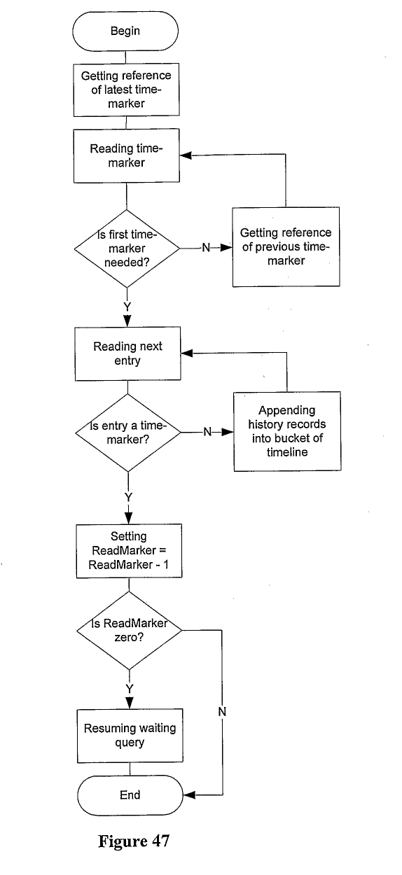

The Disk-IO Agent, performing a Read-Timepoint Task as shown in FIG. 47 in said manner, executes by:
Getting the disk reference of the latest time-marker, said disk reference having being stored in the cache;
Reading the time-marker from the referred disk;
Testing if the time-marker is the first time-marker needed to be restored;
If the time-marker is not the first time-marker needed, the Disk-IO Agent continues executing by:
Getting the disk reference of the previous time-marker from the time-marker just read;
Repeating the above sequence until the first needed time-marker is located;
Upon locating the first time-marker needed the Disk-IO Agent reads all complex records from the disk unit another time-marker is read, processing each complex record by copying the complex record into the bucket being restored; and
Decrementing the aforementioned ReadMarker, and if the result is zero, the waiting query is resumed.

### 5.3 Detailed Description of Third Preferred Embodiment

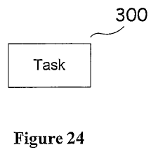

With reference to FIGS. 24 to 31 a further preferred embodiment is described here in terms of its main components and algorithms.

### 5.3.1 Components

The machine consists of six main components:
Tasks;
Agents;
Cache;
Timeline;
Disks; and
Files

### 5.3.2 Tasks

The machine achieves the desired processing, storage and query properties by executing a complex job mix. A task 300 as seen in FIG. 24 represents an individual job to be executed by the system. A task 300 is a set of one or more execution steps.

### 5.3.3 Agents

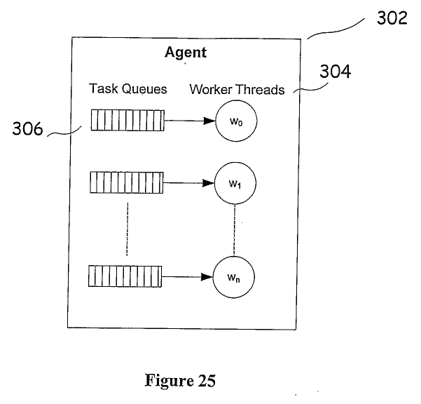

As seen in FIG. 25 an agent 302 represents a processing stage. An agent 302 is comprised of a set of operating system threads 304, where each operating system thread 304 services one or more FIFO queues containing tasks 306. An operating system thread 304 which is designed to service a queue of tasks is here within referred to as a worker.

Each worker (thread) 304 regularly inspects its queues 306, removing the first task it finds, executing a step of that task and then either appending the task onto another queue (potentially for a different worker 304 in a different agent 302) or deleting the task because it has completed its job.

In the current embodiment some queues 306 hold higher priority tasks, while other queues hold lower priority tasks. Higher priority queues are inspected and processed before lower priority queues, thereby giving preferential treatment to higher priority tasks.

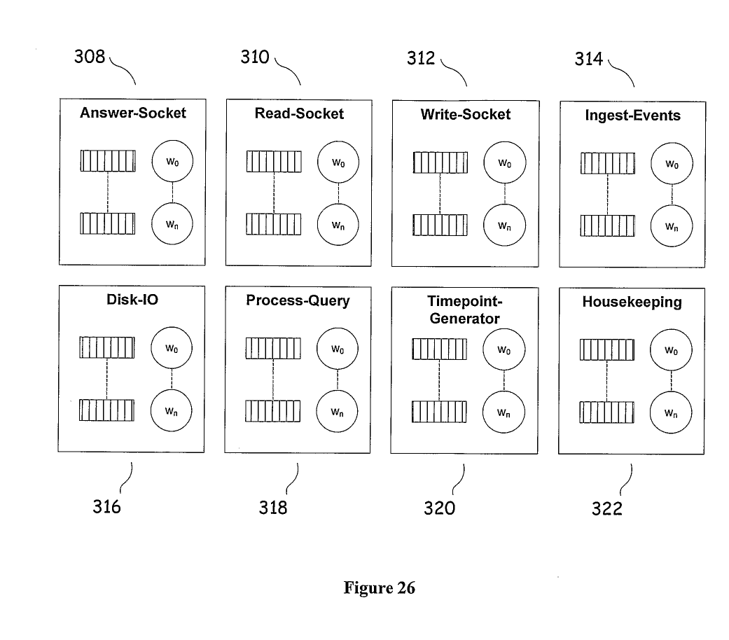

As seen in FIG. 26, the main agents in the system are:
Answer-Socket Agent 308;
Read-Socket Agent 310;
Write-Socket Agent 312;
Ingest-Events Agent 314;
Disk-IO Agent 316;
Process-Query Agent 318;
Timepoint-Generator Agent 320; and
Housekeeping Agent 322;

### 5.3.4 Cache

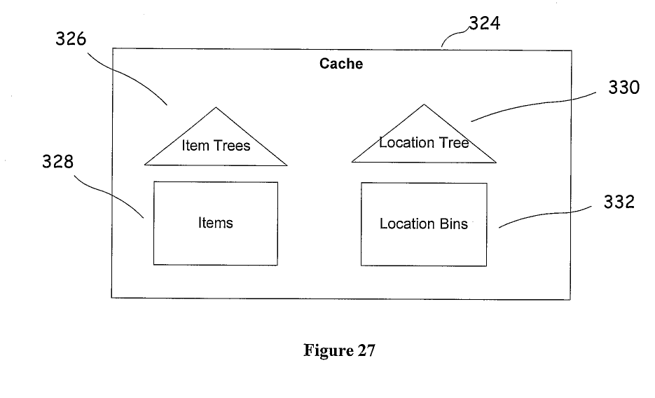

As seen in FIG. 27 the cache 324 is a set of keyed items in memory. The cache has two sections: a) the item trees 326 and b) the location bins 332. The location bins 332 can hold an item 328 at a location from the item tree 326.

Items are a computer representation of real-world objects which have been identified in an event stream. Items are keyed by their identification number and are held in one of the item trees 326. Such an identification number could, for example, be the number associated with an RFID tag or a credit card.

Reducing the probability of lock collision is an important aspect in achieving high-throughput as well as scalability. In the current embodiment each item tree is a balanced binary tree, keyed by identification number. The particular tree an item is located in is determined by a modulus function on the items identification number. Having multiple trees reduces the probability of lock collision during insert or delete.

Each location bin 332 keeps a set of one more items which are currently at that location. In the current embodiment a location bins is a set of one or more linked lists, with each list holding a set of items. The number of linked lists is a multiple of the number of CPU's in the machine, in order to reduce the probability of lock collision. The location bins are located using a simple binary tree search. The structure of the location bins 332, to facilitate a binary search, is defined by at least one location tree 330.

The list within a bin is chosen based on a hash function of the item identity.

### 5.3.5 Timeline

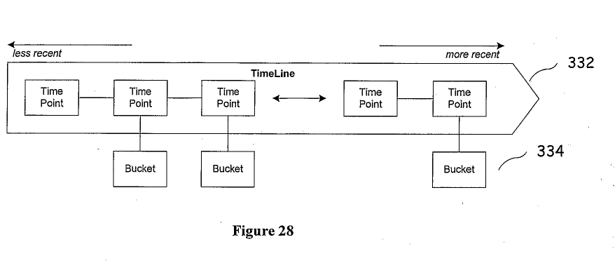

As seen in FIG. 28, as events are processed by the system, history records are appended in chronological order to a data structure called a timeline 332. This is done after the history records have been written and flushed to disk to ensure transaction integrity of the system.

The timeline 332 is divided into segments called buckets 334. This enables the system to manage its buffer space by purging an interval of the timeline and reclaim the memory if needed. Historical queries which return an interval of events, execute by first ensuring the required buckets are in memory, reloading them if not, and then selecting the appropriate subset of events which satisfy the conditions of the query.

In the current embodiment of the timeline 332 as seen in FIG. 28, the timeline 332 is divided into buckets 334 which represent a second. In the current embodiment the buckets are purged from the timeline on a least-recently used basis.

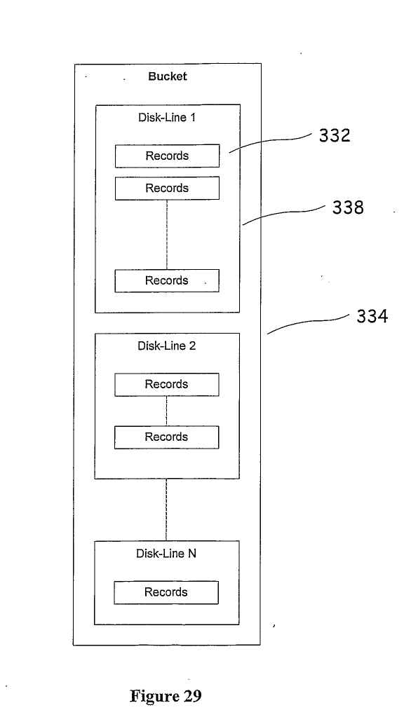

As seen in FIG. 29 each bucket 334 is a set of history records 336. The history records are located on a set of disk lines 338.

### 5.3.6 Disks

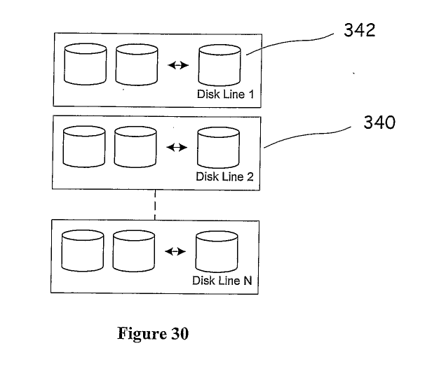

As seen in FIG. 30, To achieve high throughput, the machine organizes disks into a number of parallel disk lines 340, where a disk line 340 is one or more disks 342 representing a circular region of reusable disk space.

In the current embodiment the machine may write to all disk lines concurrently to achieve maximal throughput.

### 5.3.7 Files

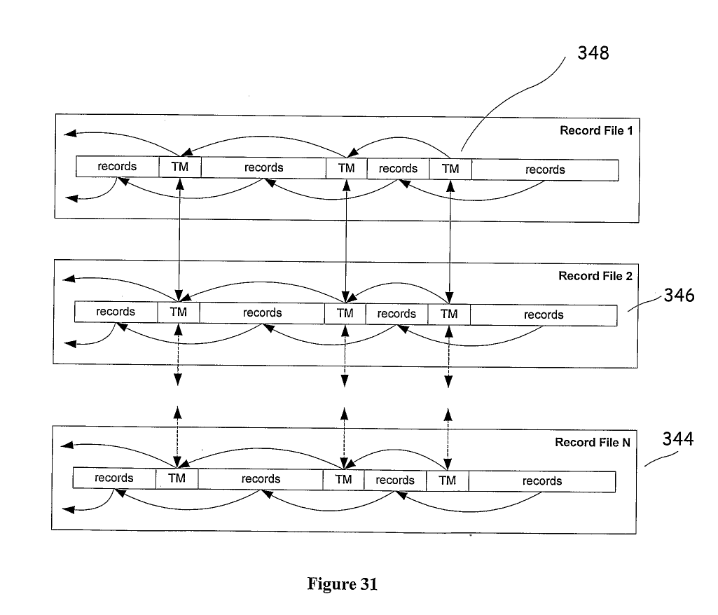

As seen in FIG. 31, the machine processes events, history records of those events are written to one or more files called record files 344 as seen in FIG. 31. A file record 344 is divided into a data structure which includes records 346 and time marks (TM) 348.

Historical queries read from these record files. The machine organizes record files 344 into groups across disk lines 340 as previously seen in FIG. 30. In each group, there is one file per line of disks the machine is managing. For example, if a group comprised Record File 1. File N, then record File 1 could be allocated to Disk line 1, thereby also allowing uniform usage of disk space. A group represents an interval of time.

In the current embodiment files are given an approximate upper limit for their size. This is checked every second. Should one file in the current group exceed this upper limit, the machine opens a new group of files and writes any new records to this new group of files. This allows files never to exceed a manageable size—for copy, backup and restore.

In the current embodiment the machine attempts to balance the write-load across the files in a file group in order to achieve maximum throughput. An alternate embodiment could balance the write-load to achieve even write distribution.

Four further aspects of file management are event grouping, previous record references, time-markers and purging.

### 5.3.8 Event Grouping

History records are not written to files one record at a time. Rather the history record produced are buffered and written as one or more groups. After the set of groups processed by a task have been written the file is flushed. This ensures the data is on the physical medium and not buffered in the computer system or storage device. The buffered history records are then added to the timeline.

### 5.3.9 Previous Record References

Each history record keeps a reference to previous history record for the same item. The head of this chain is held by the item in memory. This enables the machine to read the history of an item by reading each previous record in turn.

In the current embodiment this reference consists of a set of three numbers, representing which disk line, which file in the line, and the offset in that file.

### 5.3.10 Time-Markers

Periodically a special entry is written to each file in the current group. This entry 348 is called the time-marker 348. The purpose of the time-marker is to delineate the passage of time in the record files. The time-marker records the reference of the previous time-marker in the file.

In the current embodiment, the time-marker 348 also records the reference of the equivalent time-marker 348 in two contemporary files; and also keeps the reference of the time-markers 348 for all previous seconds in the current minute, the references for all the previous minutes in the current hour, the references for all the previous hours in the current day, and the reference to the previous day.

The purpose of these references to previous time-markers 348 is to provide a way to skip backwards to find any given time-marker, so as to find the starting location of a time interval.

An alternative embodiment is to have an array of references to time markers which are updated as time passes.

### 5.3.11 File Purging

The disk line arrangement enables disk space to be organized as a set of reusable circular regions. As disks fill up, the oldest files can be removed to make space for new files.

This has the effect that some existing references, notably references to time-markers and previous records will in fact reference time-markers and previous records in files which have been deleted. In the current embodiment the machine detects references to deleted records and does not attempt to read time markers which are known to be purged.

### 5.3.12 Algorithms

The main algorithms are encoded as tasks:
Answer-Socket Task;
Read-Socket Task;
Ingest-Events Task;
Write-Events Task;
Write-Socket Task;
Timepoint-Generator Task;
Timepoint-See Task;
Timepoint-Write Task;
Query-Request Task;
Query-Stream Task;
Query-History Task;
Restore-Timeline Task;
Purge-Timeline Task; and
Purge-Files Task;

A reader skilled in the art will observe that each of the tasks described below can be broken into a number of discrete steps. In the current embodiment, a task executes one step, is re-queued and then executed again in turn once it arrives at the front of its-queue. In this multi-tasking, multi-threaded arrangement the execution of any number of tasks can be interwoven using any number of worker threads. Carefully written, such a system executes a large number of tasks evenly.

The skilled reader will also recognize that by ensuring there are both a finite number of steps and an upper time-space processing limit to each step, a machine of this kind is a real-time system.

The skilled reader will recognize that, although the algorithms described below discuss TC/IP, other forms of interface could be readily supported. This would include, but not limited to, direct calls, inter-process messaging (pipes), shared memory and other network protocols.

### 5.3.13 Answer-Socket Task

The Answer-Socket Task tests a listening socket port for connection requests. If a connection request is present, the Answer-Socket Task creates a connected socket and spawns a Read-Socket Task for that socket.

The Answer-Socket Task runs on the Answer-Socket Agent.

### 5.3.14 Read-Socket Task

The Read-Socket Task tests a connected socket for event-data packets (data packets which are known to contain events), or query-request packets (data packets which are known to contain query requests).

If an event-data packet is read the Read-Socket Task spawns an Ingest-Events Task for that event-data packet. If a query-request packet is read the Read-Socket Task spawns a Query-Request Task for that query-request packet.

In the current embodiment a query request is a string contain a textually encoded description of the query being requested. A person skilled in the art will recognize there are a number of ways queries may be represented.

In the current embodiment events are encoded as records containing data fields, and there may be a number of events in a single packet.

The Read-Socket Task runs on the Read-Socket Agent.

### 5.3.15 Ingest-Events Task

The Ingest-Events Task processes each of the events in its associated event-data packet. As described below this processing produces one or more record-history packets.

In the current embodiment the Ingest-Events Task spawns one Write-Events Task per record-history packet.

Each event in an event-data packet is processed in the following manner:
The item is located in memory by searching the item trees using the item-id as the key. A new item is created if the item is not currently in memory;
The item is exclusively locked for update;
The item is removed from its list within its current location bin. Recall that each location has a number of lists to reduce lock contention during this operation;
The item is appended into the location bin associated with the event. In the current embodiment the list within the bin is chosen by a modulus function on the item id, so as to reduce lock contention during this operation;
Any user defined processing for the given event is executed. This produces a history record of the event;
The history record is appended into the current record-history packet. If the current record-history packet is full, a Write-Events Task is spawned to write the record-history packet, and a new record-history packet is created; and
The exclusive lock on the item is released;

The Ingest-Events task is complete when all events in the event-data packet have been processed in this manner.

The Ingest-Events Task runs on the Ingest-Events Agent.

The historical record of an item may be represented on disk in a variety of formats. One possible embodiment is to represent an item as a set of attribute-value pairs 32.

### 5.3.16 Write-Events Task

The Write-Events Task writes and flushes the associated record-history packet to the required record file. Optionally the Write-Events Task then creates a Write-Socket Task to send an acknowledgement that a subset of the events has been processed.

The Write-Events Task runs on the Disk-IO Agent.

### 5.3.17 Write-Socket Task

The Write-Socket Task writes the associated data packet to a socket. This data packet may be an acknowledgement message (acknowledging that a subset of events have been processed), or it may be a query-result data packet (containing a subset of query results).

The Write-Socket Task runs on the Write-Socket Agent.

### 5.3.18 Timepoint-Generator Task

The Timepoint-Generator Task executes periodically. When the Timepoint-Generator executes it creates a new time point in the timeline. The Timepoint-Generator then spawns a Timepoint-See Task for each specific worker in the Ingest-Events Agent.

In the current embodiment, the Timepoint-Generator Task executes once every second.

The Timepoint-Generator Task runs on the Timepoint-Generator Agent.

### 5.3.19 Timepoint-See Task

Periodically a set of Timepoint-See Tasks run on the Ingest-Events Agent—one Timepoint-See task per worker thread. Each Timepoint-See Task decrements an atomic counter—the counter originally set to be equal to the number of workers in the Ingest-Events Agent. Upon decrementing the atomic counter, should the result be non zero, the associated worker waits.

When the atomic counter reaches zero, the associated worker is deemed the deciding worker. The deciding worker then spawns a Timepoint-Write Task for each worker in the Disk-IO Agent. The deciding worker then signals all other waiting workers in the Ingest-Events Agent, so as to continue processing. Any further Ingest-Events Tasks will be executed within the context of the new time point just created by the Timepoint-Generator Task; and all new history records will be written after the time-pointer markers in the record files.

This ensures that the workers of the Ingest-Events are in lock-step for each and every timepoint, with an overhead or delay typically no longer than for the workers to finish their current Ingest-Events Task when the Timepoint-See Task is spawned.

The Timepoint-See Task runs on the Ingest-Events Agent.

### 5.3.20 Timepoint-Write Task

The Timepoint-Write Task writes and flushes a Time-Marker to the required record file.

The Timepoint-Write Task runs on the Disk-IO Agent.

### 5.3.21 Query-Request Task

The Query-Request Task compiles the associated query-request packet and produces a query plan. The act of compilation identifies the type of query (such as a stream query or a history query), and secondly generates appropriate executable code for the various clauses of the query statement (such as the where clause).

If the query is stream query, the Query-Request Task spawns a Query-Stream Task to execute the query plan, or a Query-History Task to execute a history query.

In the current embodiment the Query-Request Task produces machine code as the appropriate executable code.

The Query-Request Task runs on the Process-Query Agent.

### 5.3.22 Query-Stream Task

The objective of the Query-Stream Task is to effectively retrieve an interval of history records. The Query-Stream Task executes a stream query plan. The Query-Stream Task begins by locating the first time point in the timeline as specified in the stream query plan. The Query-Stream Task then steps through the timeline visiting each relevant time point searching for records which match the conditions specified in the where clause of the query (if any).

As the Query-Stream Task finds records which match the query conditions, the records are appended to a result data buffer.

In the current embodiment the upper size of a result data buffer is fixed. So in the current embodiment when the data buffer is full, the Query-Stream Task spawns a Write-Socket Task to send the result data buffer to the query originator.

As each time point is visited, the bucket containing the record of the events may not be in memory. Should this be the case, the Query-Stream Task spawns a Restore-Time Task for each record disk-line worker, and then suspends until the time point and record bucket has been restored. As stated below the Restore-Timeline Tasks will asynchronously restore the bucket for the required time point and then notifying the suspended Query-Stream Task.

The Query-Stream Task continues to process the time point. The Query-Stream Task ends when all relevant time points have been visited.

The Query-Stream Task runs on the Process-Query Agent.

### 5.3.23 Query-History Task

The objective of the Query-History Task is to retrieve the history records for a specific set of items. The Query-History Task executes a history query plan. The Query-History Task iteratively retrieves the history record for each item nominated in the query.

The Query-History Task retrieves the history records for a specific item by first locating that item in memory by using its identifier. The item in cache will have the disk reference to the most recent history record. The Query-History Task iteratively reads a history record, appends the history record to a result data packet, and then uses the reference in the history record to the previous history record to read that previous record.

A history record is only appended to the result data packet if it matches the conditions specified in the query. In the current embodiment the upper size of a result data packet is fixed. So in the current embodiment when the data packet is full, the Query-History Task spawns a Write-Socket Task to send the result data packet to the query originator.

The Query-History Task ends when all relevant items have been queried.

The Query-History Task runs on the Process-Query Agent.

### 5.3.24 Restore-Timeline Task

The objective of the Restore-Timeline Task is to restore a time point bucket by reading history records from record files. As there is any number of disk lines, a bucket will potentially have history records in each disk line. Consequently the Restore-Timeline Task creates a number of Read-Timepoint Tasks, one per disk to restore the history records for a given time point.

The Restore-Timeline Task runs on the Process-Query Agent.

### 5.3.25 Read-Timepoint Task

The Read-Timepoint Task first reads the latest time-marker on its specified disk line. Using the references in that time-marker, the Read-Timepoint Task iteratively reads previous time-markers until it finds the relevant time-marker. The Read-Timepoint Task then reads all history records between that time-marker and the next time-marker, and appends them onto the time point in the timeline structure in memory.

When the Read-Timepoint Task has read all history records for that time point, the Read-Timepoint Task decrements an atomic counter—the counter originally set to be equal to the number of disk lines. As there are multiple Read-Timepoint Tasks engaged in restoring the bucket for a time point, one of those Read-Timepoint Tasks will decrement the atomic counter to zero. When the atomic counter reaches zero it indicates that all cooperating Read-Timepoint Tasks have restored their history record subsets. The Read-Timepoint Task which decrements the counter to zero notifies the waiting Query-Stream Task so it may continue.

In the current embodiment the Read-Timepoint Tasks restores the nominated time point, as well as the following three seconds. This is often referred to as read-ahead.

The Read-Timepoint Task runs on the Disk-IO Agent.

### 5.3.26 Purge-Timeline Task

The objective of the Purge-Timeline Task is to reclaim memory space by removing unneeded buckets from the timeline. The Purge-Timeline Task runs periodically as defined in the system configuration. The Purge-Timeline Task executes by identifying those time point buckets have been least-recently used and deleting them.

The Purge-Timeline Task runs on the Housekeeping Agent.

### 5.3.27 Purge-Files Task

The objective of the Purge-Files Task is to reclaim disk space by removing unneeded files from the disk lines. The Purge-Files Task runs periodically as defined in the system configuration. The Purge-Files Task executes by identifying old files which are no longer needed and deleting them.

The Purge-Files Task runs on the Housekeeping Agent.

### 5.3.28 Other Tasks

A skilled reader will recognize that other forms of queries (such as location based queries) could be encoded as tasks in a manner similar to that described in this patent.

A skilled reader will also recognize that other any number of other tasks (such as those which perform user command processing, system monitoring or other housekeeping functions) could also be encoded in a similar manner.

### 6 Usage Examples

### 6.1 First Example

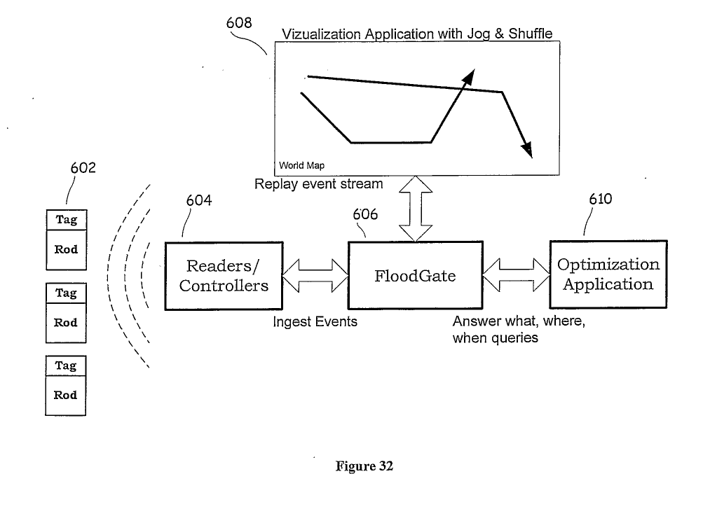

With reference to FIG. 32 the following describes an example of expected use of the machine. In this example the machine is being used to process, store and answer queries about nuclear fuel rods being tracked by RFID tags.

With reference to FIG. 32 it is seen that:
Fuel rods are attached with RFID tags—these rods are an example of real-world objects being tracked by the machine;
A set of RFID readers at a variety of different locations around the world;
A machine (the subject of this patent);
One application which displays the location of rods as they move through various distribution centers around the world; and
A second application which monitors the use and condition of rods and performs real-time scheduling optimizations.

In this example the machine would be used in the following manner:
Fuel rods and their condition are sensed by RFID readers. This sensing could be periodically so as to ascertain the state of the rod, or as the rod is moved in or out of a location. The condition or state of the rod could include environment variables such as temperature, humidity, air pressure;
In this example there are a large set of rods over a number of locations;
This automatic sensing of multiple rods in multiple locations produces an event stream which is sent to the machine;
The machine processes the event stream as it arrives. This event stream contains events. An individual event is a piece of data about the id of the rod in question, the location of the reader, the new state of the rod and the specific event. An event could be a rod is removed from a location, moved into a location, or a periodic update on the state of the rod;
In processing a rod event the machine may move the object representing the rod from one location bin to another and/or change the state within that object;
In processing events the machine produces a history of records on disk, such that those records are kept in the same chronological order as they were processed;
Connected to the machine is a Visualization Application which can display the movement and state of rods on a map of the world. The Visualization Application can display such movement and state change events as they happen. Additionally the Visualization Application could replay a previous event sequence by querying a previous event sequence interval stored on the machine. Such an interval could be filtered by a where clause which only shows the movement of specific rods. For example only show the movement and condition of spent fuel rods. Additionally the Visualization Application could be paused at any point, and the history (location and state) of specific rods could be retrieved from the machine and shown on the map; and
Also connected to the machine is an Optimization Application. This application uses information about the condition of all rods in use and the current location and movements of available rods to continuously optimize usage and routing schedules so as to maximize usage and minimize the number of outstanding unused rods in the entire supply chain.

### 6.2 Second Example

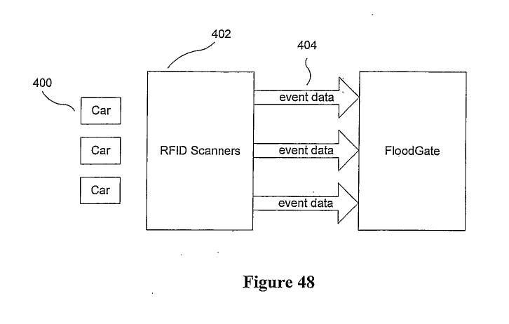

With reference to FIGS. 48 to 59 this section uses an example to describe how the machine ingests events in detail. As in FIG. 59, in this example there is a freeway which has a gantry equipped with an RFID-enabled system, known as the Tag Sensor System. The Tag Sensor System detects tags mounted within vehicles as they pass under the gantry.

FIG. 48 shows a collection of physical objects 400 approaching a group of RFID scanners 402. The RFID scanners 402 extract specific units of data 404 from the objects 400. In this case the physical objects 400 can be taken to represent a group of cars passing through scanners at a toll way.

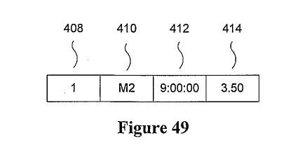

FIG. 49 shows the structured collection of information about cars 400 that have passed through the toll way RFID scanners 402. A variety of information is collected in relation to a car shown in FIG. 49. The number of the car in this case being number 1, is shown at 408. The location of the car is shown at 410, in this case M2. The time that the information was collected, in this case 900 hours is shown at 412. The value of the toll due is shown at 414, in this case $3.50.

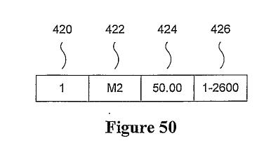

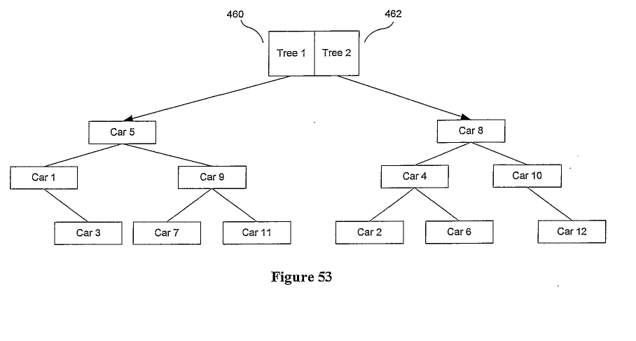

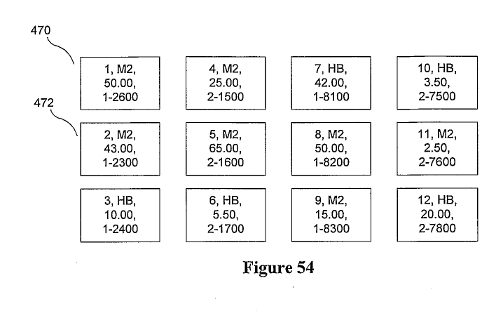

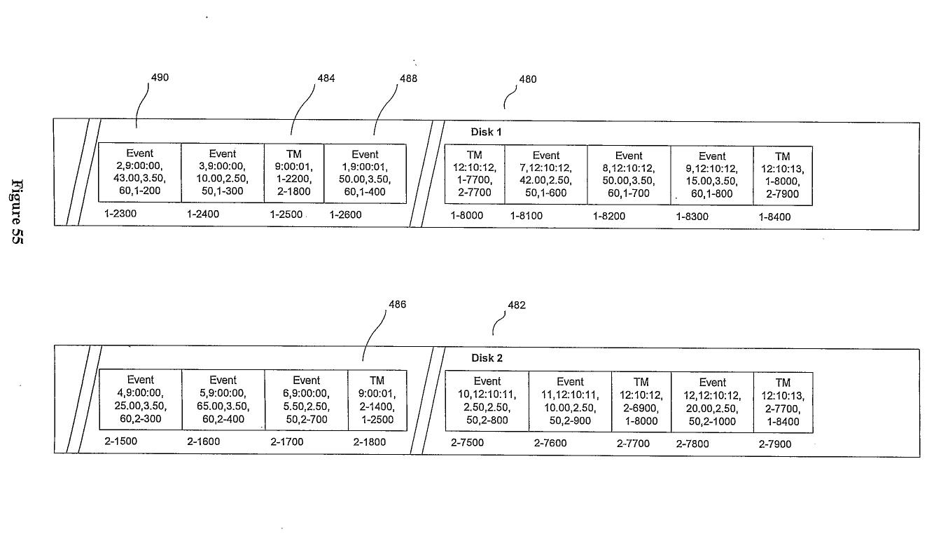

FIG. 50 shows an item kept by the system, in this case a structured collection of information about a car (items will be further discussed again in FIGS. 53-54). The number of the car, in this case being number 1, is shown at 420. The last known location, in this case the M2 is shown at 422. The value of the toll currently due and payable to date, in this case $50.00 is shown at 424. The disk reference of the last known event-record for this car, in this case 1-2600 (disk 1 offset 2600 bytes) is shown at 426.

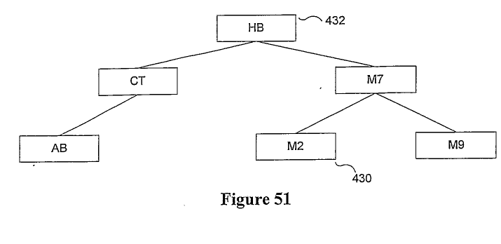

FIG. 51 shows the location binary tree of RFID readers. It will be supposed that there at least two reader locations: the M2 (standing for Motor Way 2) as shown at 430, and HB (standing for Harbour Bridge) as shown at 432.

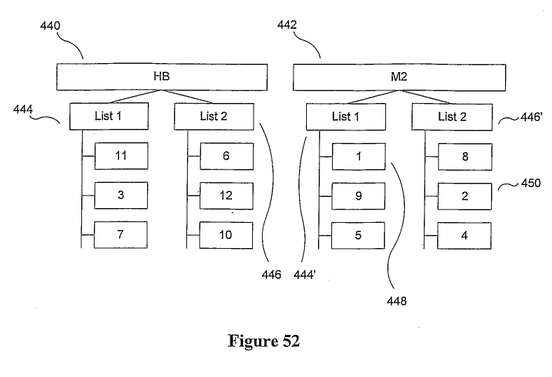

FIG. 52 shows the location bins. It will be supposed that there are at least two locations: the location bin for HB is shown at 440, the location bin for M2 is shown at 442. In this case each bin has two lists as shown at 444 and 446. In this case car 1 shown at 448 is in list 1 in M2, while car 2 shown at 450 is in list 2 in M2. A simple hash function determines which list a particular item will be in. Having a multiplicity of lists per location may be an important aspect as the feature minimizes the probability of lock contention when adding or removing an item from a location, particularly as the number of lists is increased to at least the number of CPU's in the machine or greater. Multiple lists per location allows a multiplicity of CPU's to lock and process the same location simultaneously, albeit different lists.

FIG. 53 shows the item trees. In this case there are two item trees: Tree 1 shown at 460 contains cars 1, 3, 5, 9, 7 and 11. Tree 2 shown at 462 contains cars 2, 4, 6, 8, 10 and 12. A simple hash function determines which tree a particular item will be in. Having a multiplicity of trees is a critical aspect of the invention as the feature minimizes the probability of lock contention when adding or removing an item from the machine, particularly as the number of trees is increased to at least the number of CPU's in the machine or greater. Multiple trees allows a multiplicity of CPU's to lock and process different trees simultaneously.

The location tree can be thought of as a web or networked system of references in the form of a data structure, which refer or point to scanners across a geographical area. Location trees serves as a first level of detail by mapping out what physical objects are geographically located at which points in physical space. Item trees then provide a next level of detail, where each point on an item tree is specific to a particular object that has been scanned. Accordingly, the structure of the creation of an event on a disk line is as follows: Location tree→Item Tree→Event Record.

FIG. 54 shows the items in the item tree in greater detail, as previously seen in FIG. 53. In this case there are twelve cars. At 470 is shown car 1 which was last at location M2, has a total toll due of $50.00, and the disk reference of the last event record is disk 1 offset 2600 bytes. At 472 is shown car 2 which was last at location M2, has a total toll due of $43.00, and the disk reference of the last event record is disk 2 offset 2300 bytes.

FIG. 55 shows the contents of two disks: Disk 1 at 480 and Disk 420. The time-marker entry at 484 on Disk 1 is at disk reference 1-2500 (disk 1 offset 2500 bytes) is shown marking the time-point 9:00:01, with the disk reference for the previous time-marker on that same disk being at 1-2200 (disk 1 offset 2200 bytes), and the disk reference of the time-marker on Disk 2 for the same time-point is 2-1800 (disk 2 offset 1800 bytes). The time-marker entry at 486 on Disk 2 is at disk reference 2-1800 (disk 2 offset 1800) is shown marking the time-point 9:00:01, with the disk reference for the previous time-marker on that same disk being at 2-1400 (disk 2 offset 2400 bytes).

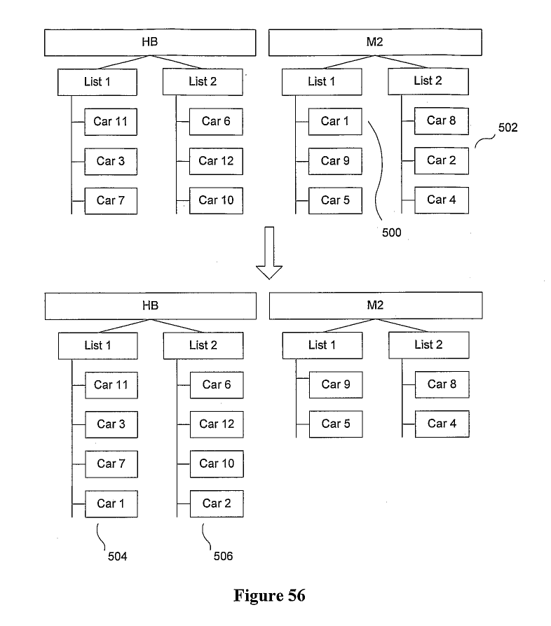

FIG. 56 shows the location bins (previously shown in FIG. 52) with the cars at their last known locations and their movement between location bins as the events are processed. At 500 is shown car 1 in list 1 of location bin M2. At 502 is shown car 2 in list 2 of location M2. At 504 is shown car 1 having been moved from its previous location into list 1 of location bin HB. At 506 is shown car 2 having been moved from its previous location into list 2 of location bin HB. If information was only kept in one list and then streamed onto the same disk in a disk line then a high-degree of collision could occur. However, the use of multi-list location bins (440 and 442 as seen in FIG. 52) independently referenced from items in multiple item trees (see FIG. 53) and the freedom to select which disk to write information to enables a congested body of information associated, for example, with a high traffic of cars at a particular location, to be independently spread and balanced across a plurality of threads within various agents so as to enable multi-stage parallel processing and then spreading and balancing the recording of information across different disks on a plurality of different disk lines, thereby enabling high speed processing and storage of information. This dispersal could otherwise not be so readily achieved were there to be an inability to monitor both the volume of information pertaining to items (cars in this case being tracked) and their physical location that occurs with the mutual and cooperative operation between location tree bins 440, 442 and item trees 460, 462.

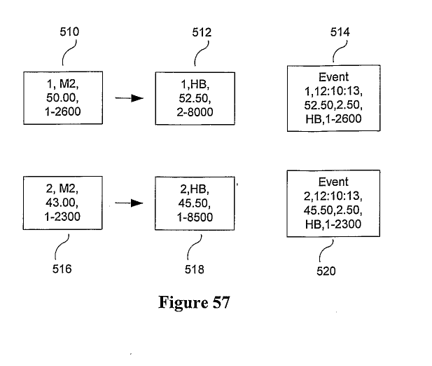

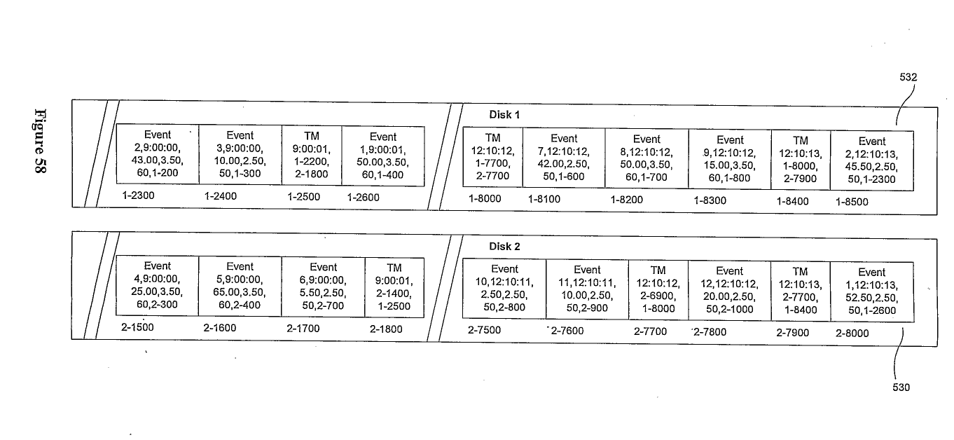

FIG. 57 shows the car items (stored in FIG. 53) being modified and the event records (previously seen in FIG. 55) being produced (the event records are streamed onto disk lines, see also FIGS. 30-31). At 510 is the original item for car 1 (see also FIG. 54), at 512 is the modified item for car 1, showing car 1 is now at HB, has a total toll due and payable of $52.50 and an event record is at disk reference 2-8000 (disk 2 offset 8000 bytes). At 514 is the event record for the event, showing car 1 at 12:10:13 had a total toll due and payable of $52.50 with a last toll of $2.50 incurred on HB and the disk reference of the previous event record for this car is 1-2600 (disk 1 offset 2600 bytes). At 516 is the original item for car 2, at 518 is the modified item for car 2, showing car 2 is now at HB, has a total toll due and payable of $45.50 and an event record at disk reference 1-8500. At 518 is the event record for the event, showing car 2 at 12:10:13 had a total toll due and payable of $45.50 with a last toll of $2.50 incurred on HB and the disk reference of the previous event record for this car is 1-2300 (disk 1 offset 2300 bytes). Multiple records have been generated at a particular instant in time. As discussed in relation to FIG. 51, any congestion of traffic associated with multiple cars, appearing at a particular location, will enable each thread associated with ingesting the events or writing to a disk line as executed by an agent to disperse the data written over a plurality of different CPUs for execution and also a plurality of different disk lines for storage.

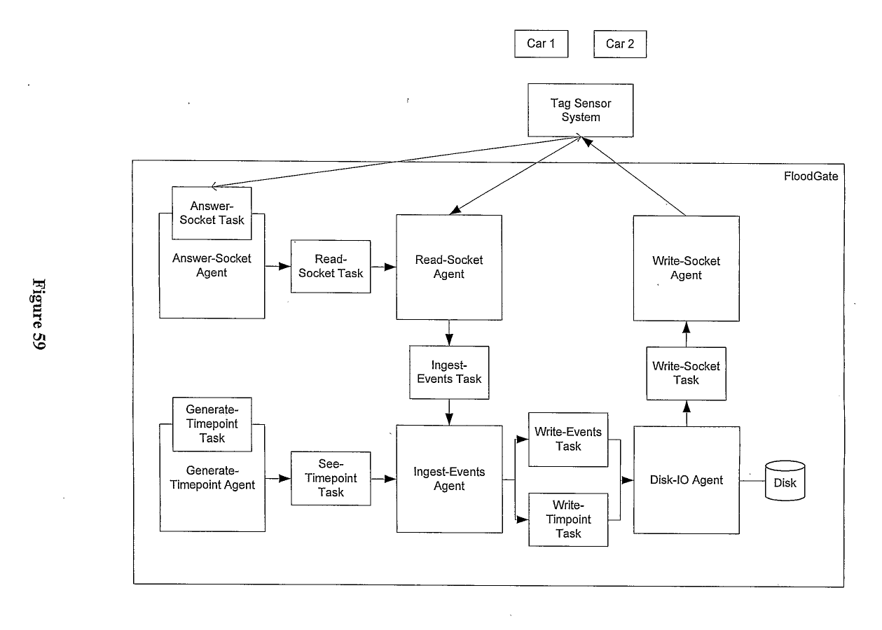

FIG. 58 shows the disks after the event records (also seen in FIG. 57) have been written. At 530 is the event record for car 1 on disk 2 which is at disk reference 2-8000 (disk 2 offset 8000 bytes). At 532 is the event record for car 2 on disk 1 which is at reference 1-8500 (disk 1 offset 8500).

As further seen in FIG. 58 (and also as seen in FIGS. 30-31), an important aspect of the embodiment shown is the sequential read and write nature of the collection of data 404 about a car 400. In particular the record of information pertaining to a car, being the data located at 420-426, will be continuously and sequentially written across a line of hard disks. This process of continuous writing and indexing, and also cross indexing of records on tracks, can occur in parallel for a plurality of different cars. However, it is to be emphasized that whilst the information associated with the car changes, the new information is recorded at a different location on a different track of a potentially different disk line. The numerical identifier for the previous disk reference 426 will now be updated; (that is a track on a disk is not written over but rather a header writing information will continue writing forwards, the header will not retrace its position to write over an old record). The previous location key 426 will now enable a user reading the record relating to the Harbor Bridge to also track back to the previous location of the car being the M2 freeway. Reference to records 530 and 532 clearly show a sequential and physical separation of the records on disk tracks that are consistent with the separation of physical records (embodying an absence of write over as in RAM).

Put alternatively, and with reference to FIG. 57, as the information stored at item 510 is updated 512 a totally new record 514 is created in a sequential and continuous manner at a new location on a new track on a disk (Record 488 and 490 of course being both indexed and cross indexed by way of time markers as in FIG. 31). In FIGS. 30 and 31, information from records, which are cross indexed by way of time markers 348, is sequentially written across a parallel row of disk lines, the choice of which disk to write to being determined by the size of the queue to access a disk in one embodiment or an another embodiment by the amount of information stored in a given disk. This feature that could otherwise give rise to unbalanced usage is minimized by the spreading of tasks over the task queues serviced by threads operating within agents.

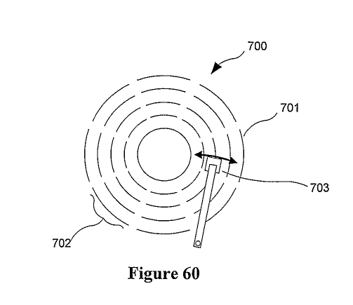

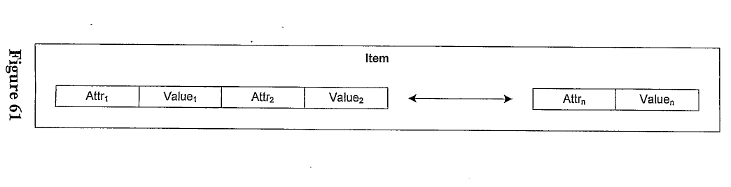

With reference to FIG. 60 there is shown a disk platter 700 having disk tracks 701 arranged concentrically on a surface thereof. Each track is divided into sectors, each sector adapted to hold typically 512 bytes of data. Read/write head 703 is adapted to move across the disc surface in either a random or sequential manner. In accordance with preferred embodiments of the invention data is laid down sequentially on contiguous sectors and sequentially from adjacent track to adjacent track.

Contemporary hardware components for such a machine may include:
Motherboard—Tyan S488-D Thunder K8QS Pro
CPU's—four dual-core AMD Opteron 875 running at 2.4 GHz, with 2 MB of L2 cache;
Memory—sixteen 2 GB units of PC3200 DRAM;
Disk Controller—Adaptec LSI 53C1030 U320 SCSI controller;
Disks—twenty four Seagate Cheetah 15.4K Ultra-320 SCSI drives; and
Network—Intel Pro 1000 MT Dual Port Adapter.

On such a machine, someone skilled in the art may expect to track of the order of 100 million objects; and ingest and replay streams in the order of 100,000 events per second.

Example operating systems may include Microsoft Enterprise Server 2003, or Red Hat Enterprise Linux. Suitable programming languages may include C/C++, while suitable development environments may include Microsoft Visual Studio.

### 7 GLOSSARY OF TERMS

ACID—short for Atomic, Consistency, Isolation, Durability. The four essential properties of an electronic transaction. Atomicity requires that a transaction be fully completed or else fully cancelled. Consistency requires that resources used are transformed from one consistent state to another. Isolation requires all transactions to be independent of each other. Durability requires that the completed transaction be permanent, including survival through system failure.

Agent—an entity that includes a set of operating system threads, see Thread below.

Answer—the act of responding to a session connect request.

Append—the act of placing an object into a queue as the last node in that data structure.

Asynchronous Operation—an operation that proceeds independently of any timing mechanism, such as a clock. For example two modems communicating asynchronously rely upon each sending the other start and stop signals in order to pace the exchange of information.

Atomic—a thing which is indivisible.

Balance—weight two or more considerations against each other.

Bin—a compartment for holding objects which can include a Linked List for holding objects.

Binary Tree—a tree data structure in which each node has at most two leaves.

Bucket—a data structure containing records. A bucket may exist in memory or on disk.

Buffer—a region of memory used to hold data in transit.

Buffering—the act of grouping objects into a buffer so as to maximize throughput when transferred.

Cache—a store of objects in memory.

Chain—a series of objects where each object has a reference to the next object.

Collision—situation where two or more threads try to use a locked object in conflicting ways. One or more of the threads must wait.

Compile—process for changing a high-level language or description (readable by a human) into a form which can be executed (by a machine).

Complex—multiple parts (as distinct to difficult).

Concurrent—two or more actions which occur at or about the same time, potentially within the same data structure.

Counter—a variable which is set to an initial value and then decremented or incremented.

Data Packet—a sequence of data values treated as a group.

Data Structure—a physical or logical relationship among data elements, designed to support specific data manipulation functions.

Decrement—the act of subtracting one from a counter.

Device—a machine designed for a particular purpose.

Disk—a data storage device comprising computer readable memory with magnetic platters (short for disk drives).

Disk Line—a subset of disks treated as a group.

Dynamic Memory Allocation—allocation of memory to a process or program at run time. Dynamic memory is allocated from the system heap by the operating system upon request from the program.

Event—something that happens or is thought of as happening.

Execute—carry out or perform one or more steps in a process.

FIFO—A method of processing a queue, in which items are removed in the same order in which they were added—the first in, is the first out; such an order is typical of a list of documents waiting to be printed.

File—a collection of related records managed as a single entity.

Flush—the act of ensuring data is completely on permanent media.

FloodGate—a stream oriented database system, embodiments of which are described in this specification.

Forwarded—the act of sending a sub-set of data from one machine to another.

Hardware—the physical components of a computer.

Heap—a portion of memory reserved for a program to use for the temporary storage of data structures whose existence or size cannot be determined until the program is running. In contrast to stack memory, heap memory blocks are not freed in reverse of the order in which they were allocated.

Ingest—take into a device, process and store accordingly.

Inspect—test the contents or state of an object.

Instruction—a direction in a computer program defining and effecting a process.

Interval—the space of time between two points in time.

Interweave—to intersperse, vary or mix with.

Linked List—a list of nodes or elements of a data structure connected by pointers. A singly linked list has one pointer in each node pointing to the next node in the list; a doubly linked list has two pointers in each node that point to the next and previous nodes. In a circular list, the first and last nodes of the list are linked.

Job—a distinct unit of work to be done by a computer system.

Lock—a variable whose value determines the right to inspect or modify an object.

LRU (least recently used)—a technique for using main storage efficiently, in which new data replace data storage locations that have not been accessed for the longest period as determined by an algorithm.

Machine Code—instructions which a computer can execute without further translation.

Multi-Tasking—A form of processing supported by most current operating systems in which a computer works on multiple task—roughly, separate “pieces” of work—seemingly at the same time by parcelling out the processor's time among different tasks.

Multi-Thread—a system which uses more than one thread to execute its work.

Node—an object in a data structure.

Notify—the act of signaling a task or thread that it may continue executing.

Object—a collection of related items which includes a routine or data wherein the object is treated as a complete entity.

Operating System—a set of programs for organizing the resources and activities of a computer.

Plan—computer representation of how to perform complex work.

Pop—To fetch the top (most recently added) element of a stack, removing that element from the stack in the process.

Port—an interface through which data is transferred.

Procedure—in a program, a named sequence of statements, often with associated constants, data types, and variables, that usually performs a single task; a procedure call can usually be (executed) by other procedures, as well as by the main body of the program Some languages distinguish between a procedure and a function, with the latter (the function) returning a value.

Procedure Call—in programming, an instruction that causes a procedure to be executed; a procedure call can be located in another procedure or in the main body of the program.

Purge—removing files from disk which are no longer required.

Queue—A multi-element structure from which elements can be removed only in the same order in which they were inserted; that is, it follows a first in first out (FIFO) constraint.

Query—a request to retrieve information previously stored within a system.

Query Condition—a set of one or more expressions describing the properties of the data to be retrieved.

Read—the act of copying data from a disk or a network into computer memory.

Real-Time—events which are analysed by a computer system as they happen.

Record—a data structure comprising a group of substantially adjacent data items.

Reference—a data value which is the address or location of a record.

Reload—to reconstruct a set of objects in memory from information in a file.

Replayed—the act of retrieving and/or emitting the data pertaining to a previously recorded event stream.

Routine—a set of instructions which perform a specific function.

Second—time unit being a sixtieth of a minute.

Signal—an indication from one thread or task to another thread or task.

Socket—an identifier for a particular service on a particular node on a network. The socket includes a node address and a port number, which identifies the service.

Software—the programs and other operating information used by a computer (as opposed to hardware).

Spawn—the act of creating a task and putting it onto a queue so it can be executed.

Stack—A portion of a computer memory used to temporarily hold information organized as a linear list for which all insertions and deletions, and usually all accesses are made at one end of the list.

Synchronous Processing—the maintenance of one operation in step with another.

System—a group of related or interconnected hardware and software components.

Task—computer representation of work to be done.

TCP/IP—Acronym for Transmission Control Protocol/Internet Protocol. A protocol suite (or set of protocols) developed by the US Department of Defense for communications over interconnected, sometimes dissimilar, networks. It is built into the UNIX system and has become the de facto standard for data transmission over networks, including the Internet. Acronym standing for Transmission Control Protocol/Internet Protocol.

Thread—in programming, a process that is part of a larger process or program; modern programs may have multiple concurrent threads.

Throughput—the amount of data being moved or work being done.

Time Point—a specific instant in time; a data structure representing such.

Timeline—a data structure indexed against time points.

Time-Marker—a special record in a file which delineates a point in time.

Virtual Memory—memory that appears to an application to be larger and more uniform than it is.

Wait—the act of a thread or task pausing until it is notified.

Write—the act of copying data from computer memory to disk or onto a network.

Write-Behind Cache—a form of temporary storage in which data is held, or cached, for a short time in memory before being written on disk for permanent storage. Caching improves system performance in general by reducing the number of times the computer must go through the relatively slow process of reading from and writing to disk.

Write-Load—the volume of data being transferred to a disk and/or the number of write actions being made against a disk.

Worker—another name for a thread. A thread within an agent.

1. A high data throughput special purpose device; said device comprising at least one processor in communication with an IO system, a memory and persistent storage in the form of at least one disk; said device adapted to receive a substantially continuous stream of status data pertaining to the current state of a finite number of objects via said IO system; said device keeping said current state of said finite number of said objects in memory while writing and reading an indefinite amount of indexed history sequentially stored on said at least one disk; thereby to construct on said at least one disk a sequenced, time-ordered history of said status data extending back to a predetermined point in time.

2. The device of claim 1 wherein said device is adapted for keeping said current state of said finite number of said objects in memory while simultaneously writing and reading an indefinite amount of indexed history sequentially stored on said at least one disk.

3. The device of claim 1 wherein said device is a hybrid of memory-oriented and disk-oriented database systems.

4. The device of claim 1 wherein said status data includes at least a first parameter and a second parameter for each said object; said first parameter comprising time data.

5. The device of claim 4 wherein said second parameter is location data pertaining to the location of said object at a given point in time.

6. The device of claim 1 comprising one or more central processing units (CPU's), memory comprising one or more memory units, one or more persistent storage units, one or more communication sockets, and a clock.

7. The device of claim 1 programmatically arranged as an interconnected set of multi-threaded processing units (here within referred to as agents) executing a set of event processing, query processing, disk I/O, network I/O and housekeeping tasks.

8. The device claim 1 wherein said device is adapted for accepting one or more events streams comprising event data about events pertaining to objects.

9. The device of claim 8 wherein said device is adapted for grouping predetermined amounts of event data into tasks which represent work to be done.

10. The device of claim 9 wherein said device is adapted for keeping the current location and state of the objects in said memory, in concurrent data structures, said data structures indexed by at least the identity and location of respective said objects.

11. The device of claim 10 wherein said device is adapted for processing said tasks, thereby changing the location and state of said objects held in said memory.

12. The device of claim 11 wherein said device is adapted for writing a stream of time-ordered records of changes to said location and state data of said objects onto said persistent storage in a sequential manner, indexed by at least time, object identity and location, where said index is also written concurrently and sequentially with said records.

13. The device of claim 12 wherein said device is adapted for executing query tasks by retrieving relevant said location and state data about said objects from said memory or said persistent storage.

14. The device of claim 13 wherein said device is adapted for locating and retrieving said objects in said memory by either said identity or said location.

15. The device of claim 14 wherein said device is adapted for locating and retrieving said records in persistent storage by either said identity or said location or by time.

16. The device of claim 1 wherein said device is set to have a finite number of steps and an upper time-space processing limit to each step thereby to facilitate real time processing.

17. A device according to claim 4, wherein said status data is stored as a record, one for each said object for a unique value of said first parameter and wherein the fully processed records are collected in groups and each group given a sequence number to be recorded with it.

18. A method of processing and storing a substantially continuous stream of status data pertaining to the state of a finite number of objects; said method comprising maintaining said current state of said finite number of said objects in memory while sequentially writing and reading an indefinite amount of indexed history of said status data to at least one disk; thereby to provide current status of said objects from memory and history of said status data from said disk.

19. The method of claim 18; said method comprising maintaining said current state of said finite number of said objects in memory while simultaneously sequentially writing and reading an indefinite amount of indexed history of said status data to at least one disk.

20.-52. (canceled)

53. A machine:
Comprising one or more central processing units (CPU's), memory comprising one or more memory units, one or more persistent storage units, one or more communication sockets, and a clock;
Programmatically arranged as an interconnected set of multi-threaded processing units (here within referred to as agents) executing a set of event processing, query processing, disk I/O, network I/O and housekeeping tasks;
Accepting one or more events streams comprising event data about events pertaining to objects;
Grouping predetermined amounts of event data into tasks which represent work to be done;
Keeping the current location and state of the objects in said memory, in concurrent data structures, said data structures indexed by at least the identity and location of respective said objects;
Processing said tasks, thereby changing the location and state of said objects held in said memory;
Writing a stream of time-ordered records of changes to said location and state data of said objects onto said persistent storage in a sequential manner, indexed by at least time, object identity and location, where said index is also written concurrently and sequentially with said records;
Executing query tasks by retrieving relevant said location and state data about said objects from said memory or said persistent storage;
Locating and retrieving said objects in said memory by either said identity or said location; and
locating and retrieving said records in persistent storage by either said identity or said location or by time.
